(19) United States
(12) Patent Application Publication
(10) Pub. No.: US 2011/0246279 A1
(43) Pub. Date: Oct. 6, 2011

(54) COMMUNITY REWARDS

(75) Inventors: David Joa, Irvine, CA (US); Timothy James Mark, Berkeley, CA (US); Helene Urban Mele, Denver, NC (US); Srinath Nagarajan, Waltham, MA (US); Kurt D. Newman, Matthews, NC (US)

(73) Assignee: BANK OF AMERICA, Charlotte, NC (US)

(21) Appl. No.: 12/752,005

(22) Filed: Mar. 31, 2010

(51) Int. Cl. G06Q 30/00; G06Q 99/00; G06Q 40/00

(52) U.S. Cl. 705/14.25; 705/14.27

(57) ABSTRACT

Embodiments of the invention provide methods, apparatuses, and computer program products for providing community rewards. For example, systems and methods are provided for: (1) accessing transaction data associated with a particular financial institution; (2) determining a threshold; (3) identifying from the transaction data a group of transactions associated with a predefined community and time period; (4) aggregating a particular aspect of the group of transactions associated with the predefined community to determine a community total; and (5) determining that a reward should be provided to the community based on a comparison of the community total and the threshold. In some embodiments, the predefined community is defined by a particular geographic area. In other embodiments, the predefined community is created by the consumers themselves.

### FIELD

In general, embodiments of the invention relate to methods, apparatuses, and computer program products for providing community rewards based on a community's transactions.

### BACKGROUND

Currently, people are becoming more community-oriented such that people in their respective communities try to reinvest back into their communities. For example, people often try to patronize businesses located in or involved with their local community. People within a particular community also get to know the community through local activities and involvement with local organizations. Such involvement in local activities and organizations can often lead to a better understanding of the needs and opportunities associated with the local community. In these ways, people try to better their local communities. People also like to feel like they are a part of a community that works together to achieve common goals. As such, systems and methods are always needed to help people become more connected with their local communities.

Furthermore, businesses are constantly trying to find new ways to attract customers. Businesses also try to be good community members by participating and sponsoring local community events, projects, and organizations. Businesses with multiregional locations, however, may find it difficult to connect with customers in any one community because of their broader focus. Therefore, systems and methods are needed to help businesses connect to local communities and to help businesses to attract customers generally.

### BRIEF SUMMARY

Embodiments of the invention address these and/or other needs by providing methods, apparatuses, and computer program products for providing community rewards. The following presents a simplified summary of one or more embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its sole purpose is to present some concepts of one or more embodiments in a simplified form as a prelude to the more detailed description that is presented later.

For example, some embodiments of the invention provide systems and methods configured for: (1) accessing transaction data associated with a particular financial institution; (2) determining a threshold; (3) identifying from the transaction data a group of transactions associated with a predefined community and time period; (4) aggregating a particular aspect of the group of transactions associated with the predefined community to determine a community total; and (5) determining that a reward should be provided to the community based on a comparison of the community total and the threshold. In some embodiments, the predefined community is defined, at least in part, by a particular geographic area. In other embodiments, the predefined community is defined, at least in part, by a particular one or more merchants. In still other embodiments, the predefined community is defined at least in part by a social or familial group and customers can choose whether to be members of the group for purposes of the community rewards program. In some such embodiments, customers can also create the community definition themselves by, for example, creating a particular social or familial community and inviting others to join the community.

More particularly, some embodiments of the invention are directed to a system configured to offer a reward to an entity or group of entities based on the aggregate purchases of either one customer or a plurality of customers made within a particular geographic area using a particular financial institution, where the geographic area is a subset of the geographic area covered by the financial institution's transactions generally. For example, in one embodiment a bank determines the total number of transactions made by its customers within a particular city over a particular time period. When the total number of transactions reaches a pre-defined target amount, the bank and/or merchants within the particular city issue a reward to the bank's customers in the city. The reward may be, for example, a discount at one or more merchants within the city, a credit applied to the accounts of the customers making transactions in the city, a donation to a charity doing work in the city, an investment into a project within the city, and/or any other type of reward.

Other embodiments of the invention are directed to a system configured to offer a reward to an entity or group of entities based on the aggregate purchases made by a plurality of customers at a particular merchant or group of merchants using a particular financial institution. For example, a bank could track all purchases made at a particular merchant using a bank-issued credit or debit card. When the aggregate of all purchases made at the merchant by the bank's cardholders reaches a predefined target amount, the bank and/or the merchant could issue a reward. The reward may be, for example, a discount to all of the bank's customers, a discount to all of the merchant's customers, a donation to a charity, and/or any other type of reward.

The features, functions, and advantages that have been discussed and other features, functions, and advantages may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a flow chart illustrating a method for providing community rewards in accordance with some embodiments of the invention;

FIG. 2 provides a block diagram of a system for providing community rewards in accordance with some embodiments of the invention;

FIG. 3A provides a flow chart illustrating a method for providing geography-based community rewards in accordance with some embodiments of the invention;

FIG. 3B provides a block diagram of a system for providing geography-based community rewards in accordance with some embodiments of the invention;

FIG. 4A provides a flow chart illustrating another method for providing geography-based community rewards in accordance with some embodiments of the invention;

FIG. 4B provides a block diagram of another system for providing geography-based community rewards in accordance with some embodiments of the invention;

FIG. 5A provides a flow chart illustrating a method for providing merchant-based community rewards in accordance with some embodiments of the invention;

FIG. 5B provides a block diagram of a system for providing merchant-based community rewards in accordance with some embodiments of the invention;

FIG. 6A provides a flow chart illustrating a method for providing geography and merchant-based community rewards in accordance with some embodiments of the invention;

FIG. 6B provides a block diagram of a system for providing geography and merchant-based community rewards in accordance with some embodiments of the invention;

FIG. 7 provides a flow chart of a method of viewing information about and setting preferences for a community rewards program in accordance with an embodiment of the invention;

FIG. 8 is an example of a graphical user interface of a community rewards program illustrating preference options presented to a user in accordance with one embodiment of the invention;

FIG. 9 is an example of a graphical user interface of a community rewards program illustrating other preference options presented to a user in accordance with another embodiment of the invention;

FIG. 10 is an example of a graphical user interface illustrating notifications to a user of progress made in meeting a purchase target threshold in accordance with an embodiment of the invention;

FIG. 11 is an example of a graphical user interface illustrating preference options presented to a user in accordance with an embodiment of the invention; and

FIG. 12 is an example of a graphical user interface illustrating a presentation of rewards earned in accordance with an embodiment of the invention;

FIGS. 13A and 13B combine to provide a flow chart illustrating another example of a method for managing community rewards in accordance with an embodiment of the invention; and

FIG. 14 is a flow chart of yet another example of a method for managing community rewards in accordance with another embodiment of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

It should be understood that terms like “bank” and “financial institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, credit card companies, payment network companies (e.g., Visa®, MasterCard®, American Express®, etc.), and/or the like. Additionally, disclosed embodiments may suggest or illustrate the use of agencies or contractors external to the financial institution to perform some of the calculations, data delivery services, data processing services, and/or authentication services. These illustrations are examples only, and an institution or business can implement the entire invention on their own computer systems or even a single work station if appropriate databases are present and can be accessed.

As described briefly above, embodiments of the invention relate generally to aggregating certain transactions, such as purchases and/or other financial transactions, for a particular community and providing rewards to the community based on the aggregate of the community's transactions. As described in greater detail below, the community may be at least partially based on geography, merchant, product, financial institution, customer, customer input, transaction type, other transaction attributes, and/or combinations of the above. For example, in one embodiment, a bank identifies all of its customers' bank card (i.e., credit or debit card) transactions made within a particular city and then makes donations to organizations within the city whenever the total transactions within the city reach predefined transaction thresholds. In this way, in this example, customers in that city may prefer to use this particular bank over other banks knowing that every transaction that they make moves their city closer to benefiting from some donation or investment by the bank. In another example, the bank identifies all of its customers' bank card (i.e., credit or debit) transactions made with a particular merchant and then the merchant and/or the bank provide a discount or donation whenever the total transactions with the merchant reach certain predefined transaction thresholds. In this way, in this example, customers can, as a community, work toward achieving a particular discount, donation, or other reward by frequenting a particular merchant and encouraging others to do the same. In still another example, customers create their own communities based on, for example, social or familial relationships and the bank then aggregates aspects of the transactions made by these communities and provide rewards to the communities based on the aggregations.

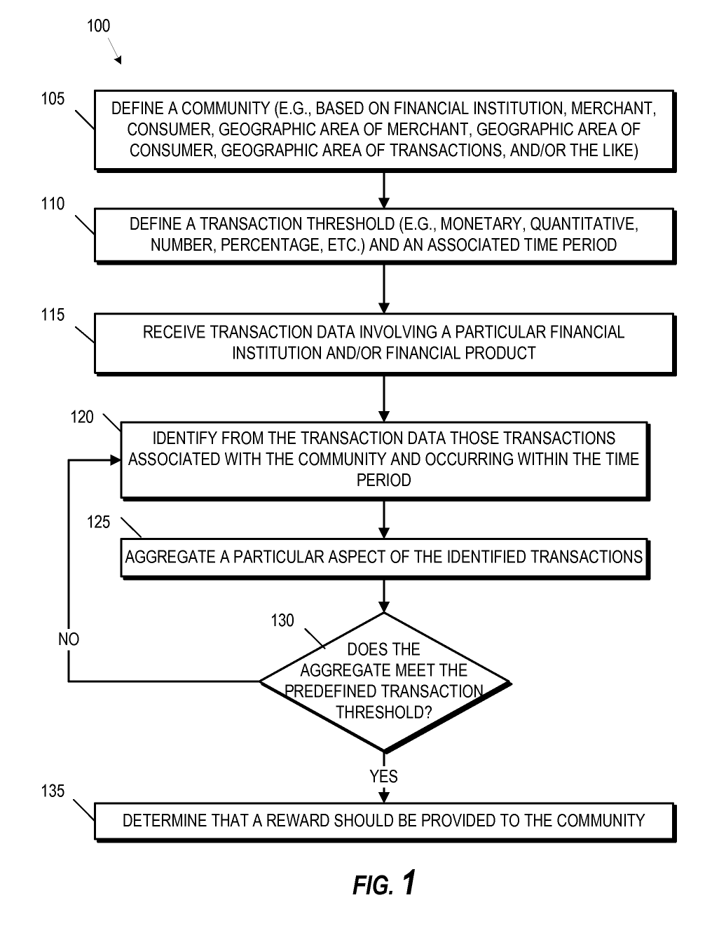

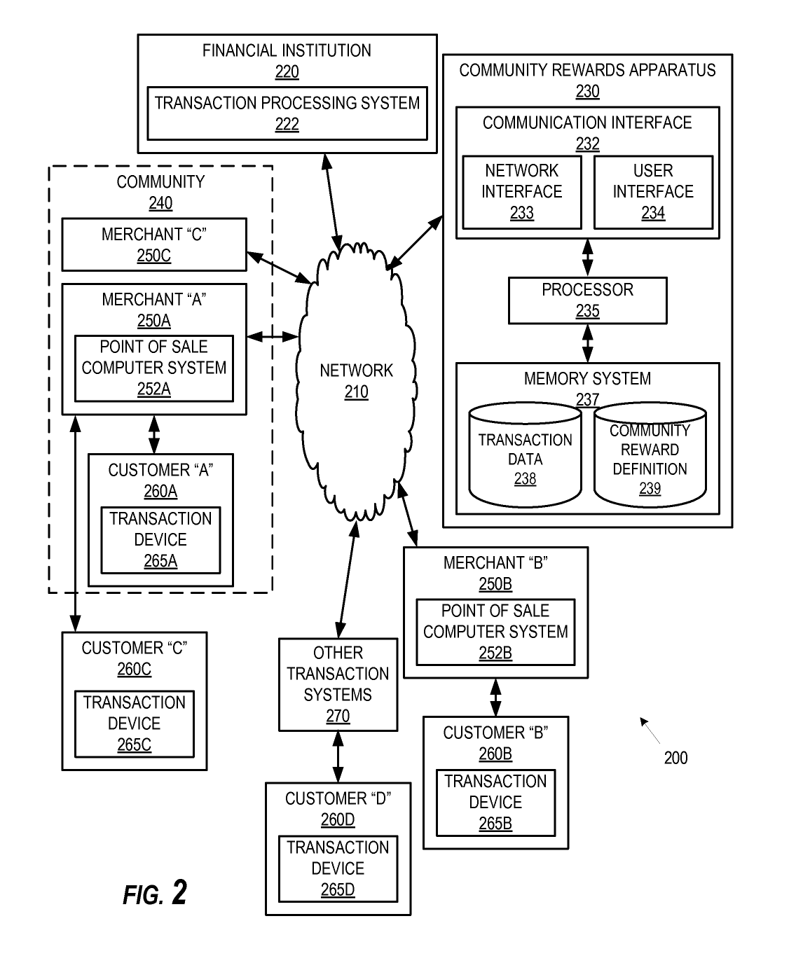

FIGS. 1 and 2 provide a general illustration of a method and system, respectively, for providing community rewards in accordance with some embodiments of the invention. As illustrated by block 105 in FIG. 1, the method 100 involves defining a community. As described in greater detail below, the community may be based on geography, merchant, product, financial institution, customer, customer input, transaction type, other transaction attributes, and/or combinations of the above. For example, in some embodiments, the community is defined by a particular geographic area, such as a city, town, village, county, state, or other municipality. In other embodiments, the community is defined as the customers of a particular merchant or group of merchants. In still other embodiments, the community is defined by the customers of a particular merchant located within a particular geographic area. In still other embodiments, the community is defined as the customers of a financial institution that are also associated with a particular social media website or group of social media websites (e.g., Facebook, Twitter, Linkedin, etc.). In still other embodiments, the community is defined as consumers who report purchase transaction information to a particular financial institution and who are not customers of that particular financial institution. For example, a bank may collect paper or digitized purchase transaction receipts, bank and credit product statements, or other evidence of payment for purchases from a non-bank customer. Still other examples of communities in accordance with embodiments of the invention are described in more detail elsewhere herein. The community definition may be created by a financial institution, a merchant, the community itself, a consumer, and/or other users of the community rewards system. For example, in one embodiment of the invention, customers of a particular bank can create their own community definitions. For instance, a group of customers could log into online banking and go to a community creation tool and define a community as members of a particular group, such as a specific Girl Scout Troop or family. Other customers could then join this group and then work together to achieve certain rewards based on their aggregated purchase data. In some embodiments, creators and/or members of these customer-defined communities can invite others to join their community via private or public invitation. Private invitations may require a password, a direct email from a member, or other authentication procedures. In one embodiment, a customer of a bank can use her online banking authentication procedures to also authenticate herself for purposes of joining a private social or familial community to which she was invited to join.

As illustrated by block 110, the method 100 further involves defining a transaction threshold and an associated time period. The transaction threshold is a target value or other rule that, when met, determines whether a community reward should be awarded. The transaction threshold may be, for example, a number of transactions, a value of transactions, a percentage of transactions, and/or the like. The threshold is often also associated with a time period. The time period determines which transactions should be counted toward the threshold based on, for example, when the transactions were made. The time period may be an hour, day, week, month, quarter, year, decade, and/or any other time period. The time period may be defined by a start date and an end date or may be defined by only either a start date or an end date. For example, if only an end date is provided, the time period may be defined as the period between the current date and the end date or the period between the date of the earliest transaction in the transaction data and the end date. If only a start date is provided, the time period may be defined as the period between the start date and the current date, the period between the start date and some infinite or indefinite end date, or the period between the start date and the date at which the transaction threshold is met. In one example embodiment, the transaction threshold is the total number of transactions that must be conducted in the predefined community within the predefined time period in order for the reward to be provided. For example, the transaction threshold may be one-thousand transactions in a particular town in a month. In another example embodiment, the transaction threshold is the total value of transactions conducted in the predefined community within the predefined time period in order for the reward to be provided. For example, the transaction threshold may be ten-thousand dollars in total purchases made by a particular bank's customers from a particular merchant within a month. In still another example embodiment, the transaction threshold is adjusted based on the time of the transaction. For example, a bank or merchant may increase the total number of transactions that are conducted in the predefined community within the predefined time period by launching promotional sales within a narrow time frame by delivering sales notifications via social media websites such as Facebook.

As illustrated by block 115, the method 100 further involves receiving transaction data. In one embodiment, the transaction data includes information about only transactions involving a particular financial institution and/or financial product. For example, the community rewards program is, in some embodiments, only provided through a certain bank or other financial institution and only counts transactions that involve the customers of the bank or other financial institution. In other embodiments, the transactional data includes information about transactions not associated with the particular financial institution providing the community rewards program. For example, a non-bank customer may self-report transaction information to the bank providing the community rewards program. In some embodiments, the community rewards program is tied to particular types of accounts, cards, payment devices, or other financial products and, as such, only transactions made using these financial products are counted toward meeting the threshold. For example, a financial institution may offer a special “community rewards” credit card and define the transaction data and/or community as including only transactions made using the community rewards credit card.

The transaction data may be received in various ways, in some embodiments the transaction data is received from a financial institution. In other embodiments the transaction data is received directly from the “point of sale” at which the transaction occurred. For example, in one embodiment the community rewards program is operated by a bank and the transaction data is received in the form of electronic authorization requests received from merchant point-of-sale computer systems whenever a purchase or other transaction is made by a customer of the bank. Such authorization requests may include, for example, a merchant code identifying the merchant and the merchant's location, an account number or other customer identifier, a card number or other financial product identifier, a date, a transaction amount, one or more product identifiers, and/or the like. All of this data and/or other data may then be stored as transaction data. In other embodiments of the invention, the community rewards program is operated by an entity that is not a traditional financial institution and that, instead, receives transaction information by accessing a financial institution's database of transaction information.

As represented by block 120, the method 100 then involves identifying from the transaction data those transactions associated with the predefined community, including predefined virtual communities, and occurring within the predefined time period. In some embodiments, a computer periodically searches the transaction data for qualifying transactions. In other embodiments, a computer evaluates each transaction as it is received.

As represented by block 125, the method 100 further involves aggregating a particular aspect of the identified (i.e., qualifying) transactions. The particular aspect may be number of transactions, value of the transactions, payment method type of the transactions, time of the transactions, value of the transactions minus taxes and fees involved in the transactions, and/or any other aspect of the transactions. For example, in one embodiment the number of qualifying transactions is merely counted to determine a total number of qualifying transactions. In another example embodiment the value of the qualifying transactions is aggregated to determine a total value for all qualifying transactions. In still other embodiments of the invention the average qualifying transaction is determined or the percentage of qualifying transactions relative to all transactions is determined.

As illustrated by decision diamond 130, the aggregate of the particular aspect of the qualifying transactions is compared to the predefined transaction threshold to determine if the aggregate meets the threshold. Depending on the aggregated aspect of the transactions and how the threshold is defined, the aggregate may “meet” the transaction threshold by, for example, being equal to, greater than, and/or less than the transaction threshold. For example, in one embodiment a computer determines that the aggregate is one-hundred transactions and determines that the aggregate meets a transaction threshold of ninety transactions if it is greater than or equal to ninety transactions.

As illustrated in FIG. 1, if it is determined that the aggregate does not meet the predefined threshold, then the procedures returns to block 120 and continues to identify other qualifying transactions, recalculate the aggregate, and compare the aggregate to the threshold. When the aggregate does meet the threshold, the procedure proceeds to block 135.

As represented by block 135, once the threshold is met, a determination is made that a reward should be provided to the community. As described above, the reward may be, for example, provided to an entity associated with the community. For example, the reward may be a donation to a charity associated with the community, a payment to an individual or group of individuals associated with the community, an investment in a business associated with the community, a donation to a governmental organization associated with the community, a donation or investment in a community project, and/or any other type of reward. The reward may be provided to the community by being provided directly to one or more members of the community or indirectly to one or more organizations or other entities associated with the community.

The reward may be provided by a financial institution, such as a financial institution managing the community rewards from and/or associated with the transaction data. In other embodiments, the reward may be provided by a merchant associated with the transaction data, a governmental agency or organization, other organizations, one or more consumers or consumer groups, the community, and/or any other entity. In this regard, in some embodiments of the invention, after it is determined that a reward should be provided to the community, a reward is triggered. Triggering the reward may involve, for example, providing the reward, notifying another device or entity that a reward should be provide to the community, prompting an entity to select a reward, initiating a process associated with providing a reward, and/or the like.

FIG. 2 provides a block diagram of a system 200 for providing community rewards in accordance with some embodiments of the invention. For example, in one embodiment, the system 200 is configured to perform the process of FIG. 1 and/or of other figures provided herein. As illustrated, the system 200 generally includes a network 210, a financial institution 220, a community rewards apparatus 230, a plurality of merchants 250, other transaction systems 270, a plurality of customers 265, and a community 240.

The financial institution 220 may be any financial institution associated with one or more financial transactions, such as purchase transactions or other payments for goods or services, monetary withdrawal transactions, monetary deposit transactions, monetary transfer transactions, investment transactions, sale transactions, and/or the like. In this regard, the financial institution 220 generally includes a transaction processing system 222 configured to receive transaction data from point-of-sale (POS) computer systems 252 at various merchants 250 and/or from other transactions systems 270 such as automated teller machines (ATMs) and/or the like. For example, in one embodiment of the invention the financial institution 220 is a bank configured to receive transaction data about its customers' transactions. In other embodiments of the invention, the financial institution is some other financial institution involved in such transactions, such as the bank for the merchant, an intermediary bank, or a payment network institution such as Visa®, MasterCard®, American Express®, and/or the like.

In general, the financial institution 220 is communicably coupled to a plurality of merchants 250, such as Merchant A 250A, Merchant B 250B, and Merchant C 250C, via network 210. The financial institution 220 may also be communicably coupled to other transaction systems 270, such as ATMs. The network 210 may be made up of any one or more types of network, such as a wireless network, wireline network, wide area network, global area network, local area network, telephone network, cellular network, Internet, intranet, virtual private network, secure proprietary network, payment network, one or more direct connections, and/or the like. The network 210 may include multiple networks for handling different functions and transmissions described herein. The network 210 may include any number of entities and/or devices for transmitting and/or processing communications and/or other data passed through the network. For example, in some embodiments, with respect to communication of transaction information from a merchant 250 to the financial institution 220, the network 210 may include one or more other financial institutions such as an intermediary bank and/or payment network institution.

The merchants 250 may be any type of merchant, such as a brick-and-mortar retail store, an online retailer, a wholesaler, an individual, a venue, and/or the like. These merchants often have a POS computer system 252, such as POS computer system A 252A at Merchant A 250A and POS computer system B 252B at Merchant B 250B. The POS computer systems 252 generally include computer systems configured to identify a transaction request, request approval of the transaction, and/or request financial processing of the transaction. In this regard, the POS computer systems 252 often have a transaction device reader, such as a card scanner, configured to read a customer's transaction device, such as a bank card. The POS computer systems 252 also generally each have a user input device that allows the customer and/or a merchant representative to enter information into the computer system. The POS computer systems 252 generally also have a user output device configured provide customers and/or merchants with information. The POS computer systems 252 also each have a network interface configured to communicate with one or more devices, such as the transaction processing system 222, over the network 210. In some embodiments, the POS computer systems 252 also have other machine-readable code readers, such as barcode readers, configured to identify products or other objects of a transaction. In some embodiments the POS computer system 252 is a computer system handling e-commerce transactions over the Internet and, as such, is configured to communicate with a remote customer input/output device via the Internet. In other embodiments the POS computer system 252 is a computer system configured to communicate with mobile payment devices to receive mobile payments.

As further illustrated in FIG. 2, the system 200 generally includes a plurality of customers 260, such as Customer A 260A, Customer B 260B, Customer C 260B, and Customer D 260D. These customers 260 interact with the merchants 250, the POS computer systems 252, and/or other transaction systems 270 to make financial transactions involving the customer 260 and the financial institution 220. In this regard, the customers 260 generally each carry a transaction device 265 used to make financial transactions with POS computer systems 252 and/or other transaction systems 270. In some embodiments, the customers 260 are customers of the financial institution 220 in that their transaction devices 265 are tied to the financial institution 220. For example, a customer's transaction device 265 may identify a credit or debit account maintained by the financial institution 220 on behalf of the customer. In another example, a customer's transaction device 265 may require use of a particular payment network and the financial institution 220 may maintain that particular payment network. In still other embodiments, the transaction device 265 may not be tied to the financial institution 220, such as in embodiments where the financial institution 220 is the merchant's bank is not necessarily the customer's bank.

FIG. 2 specifically shows an example where Customer A 260A is using Transaction Device 265A to interact with POS Computer System 252A in order to engage in a financial transaction with Merchant A 250A. Customer C 260C is also engaging in a financial transaction with Merchant A 250A by using Transaction Device 265C to interact with POS Computer System 252A. Customer B 260B is using Transaction Device 265B to interact with POS Computer System 252B in order to engage in a financial transaction with Merchant B 250B. Customer D 260D is using Transaction Device 265D to interact with some other type of transaction system 270 such as an ATM. In an embodiment where all of these transactions are associated with the financial institution 220 (e.g., where all of the customers 260 are using accounts held with the financial institution 220 to make the financial transaction), the financial institution 220 receives data about each of the transactions and stores this information in a memory device in the transactions processing system 222.

The system 200 also includes a community rewards apparatus 230 configured to manage many of the functions of the community rewards program described herein. The community rewards apparatus 230 may be a single computer workstation or may be made of a plurality of computers and/or other devices. The community rewards apparatus 230 may be owned and/or maintained by the financial institution 220 and may be combined with the transaction processing system 222. In other embodiments, the community rewards apparatus 230 is owned and/or maintained by an entity other than the financial institution 220. For example, the community rewards apparatus 230 may, in some embodiments, be owned and/or operated by a third-party community rewards program vendor that contracts with the financial institution 220 to access the financial institution's transaction data and maintain a community rewards program.

As illustrated in FIG. 2, the community rewards apparatus 230 generally includes a communication interface 232. As used herein a “communication interface” generally includes hardware, and, in some instances, software, that enables a portion of the system 200, such as the community rewards apparatus 230, to transport, send, receive, and/or otherwise communicate information to and/or from a user and/or the communication interface of one or more other portions of the system 200. For example, the communication interface 232 of the community rewards apparatus 230 may include a network interface 233 and a user interface 234. The information communicated to and/or from a user or between portions of the computer system 200 by the community rewards apparatus 230 or other portion of the computer system 200 is securely transported by encrypting the information and/or using user authentication methods.

As used herein, a “network interface” generally includes hardware, and, in some instances, software, that enables a portion of the system 200, such as the community rewards apparatus 230, to transport, send, receive, and/or otherwise communicate information to and/or from the network interface of one or more other portions of the system 200 via the network 210. For example, the network interface 233 of the community rewards apparatus 230 may include a modem, server, electrical connection, and/or other electronic device that communicably connects the community rewards apparatus 230 to another electronic device on the network 210 and communicates using a network communication protocol.

As used herein, a “user interface” generally includes one or more user output devices, such as a display and/or speaker, for presenting information to a user. In some embodiments, the user interface further includes one or more user input devices, such as one or more buttons, keys, dials, levers, directional pads, joysticks, accelerometers, controllers, microphones, touchpads, touchscreens, haptic interfaces, scanners, motion detectors, cameras, and/or the like for receiving information from a user. For example, in some embodiments, the user interface 234 includes the input and display devices of a personal computer, such as a keyboard and monitor.

As further illustrated by FIG. 2, the community rewards apparatus includes a processor 235 operatively coupled to the communication interface 232 and a memory system 237. As used herein, a “processor,” such as the processor 235, generally includes circuitry for implementing the audio, visual, and/or logic functions of a portion of the system 200. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device. For example, with regard to the community rewards apparatus 230, the processor 235 may be configured to perform one or more functions attributed herein to the community rewards apparatus 230 by executing computer-executable program code of a community rewards application stored in the memory system 237 of the community rewards apparatus 230.

As used herein, a “memory system” or just plain “memory” may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory system 237 of the community rewards apparatus 230 includes transaction data 238 and community reward definitions 239 stored therein. The transaction data 238 includes data about a plurality of transactions, such as a plurality of transactions associated with the financial institution 220. The transaction data 238 may include, for example, such information as identifying information for the customer involved in the transaction, identifying information for the merchant involved in the transaction, information about the amount of the transaction, information about the type of transaction (e.g., purchase, return, withdrawal, deposit, etc.), information about products or other objects involved in the transaction, information about the geographic location of the transaction, information about the timing of the transaction (e.g., date and/or time), information about an address for the customer, information about an address for the merchant, demographic information about the customer, demographic information about the merchant, identifying information about the one or more financial institutions involved in the transaction, identifying information about the one or more financial products involved in the transaction, and/or any other type of information that may exist about a financial transaction, including any other information about the parties involved in the financial transaction.

The community reward definition 239 includes rules, thresholds, names, and/or other specifications that define one or more community rewards. For example, a community reward definition 239 may include information about the reward, such as the type of reward, the amount of the reward, the beneficiaries of the reward, when the reward will be given, how the reward will be given, who should me notified that a reward should be given, and/or the like.

The community reward definition 239 may also include information defining a community associated with the reward. The community definition may include such information as the name of a city, town, village, state, county, country, and/or other municipality. The community definition may include other geographic area identifying information such as one or more zip codes, area codes, street names, intersections, street addresses, regions, GPS coordinates, longitude and latitude coordinates, and/or any other type of geographical identifier or boundary. The community definition may include demographic information or other information identifying particular customers or types of customers, one or more particular merchants or types of merchants, one or more particular financial institutions or types of financial institutions, one or more particular financial institutions or types of financial institutions, one or more particular transactions or types of transactions, one or more particular products or types of products involved in the transaction, and/or the like. For example, a community definition may define a community such that transactions associated with the community include only any transactions made by customers of a particular financial institution and made within a certain geographic area. In another example, a community definition may define a community such that transactions associated with the community include only any transactions made by customers of a particular financial institution where the customer lives within a certain geographic area. In another example, a community definition may define a community such that transactions associated with the community include only any transactions made by customers of a particular financial institution with a particular merchant. In yet another example, a community definition may define a community such that transactions associated with the community include only any transactions made by customers with a particular merchant in a particular geographic area.

The community reward definition 239 may also include information about a time period during which transactions will be counted toward meeting the reward requirements. For example, the community reward definition 239 may include such information as a start date, an end date (e.g., expiration date), a length of time (e.g., day, week, month, quarter, year, etc.), one or more rules for determining start or end dates, and/or any other information that can be used to determine whether the timing of a transaction enables it to count toward a particular reward's transaction requirements.

The community reward definition 239 may also include information about how the community rewards apparatus 230 will determine that the defined community's transactions should result in the defined reward. In other words, the community reward definition 239 includes community transaction requirements associated with the reward. For example, the community transaction requirements may include one or more transaction thresholds that the community transactions must meet to trigger the reward. As such, the community reward definition 239 may include information defining one or more transaction thresholds. These thresholds may be, for example, a particular number of transactions, a particular total value of transactions, a particular average transaction value after a particular number of transactions, a particular frequency of transactions, and/or the like. Similarly, the community reward definition 239 includes information about how to aggregate the community transactions, such as which aspects of the transactions to identify and determine a community total for, as well as information about how to compare the community total to the threshold (e.g., equal to, greater than, less than, greater than or equal to, less than or equal to, etc.),

For example, in one embodiment of the invention, the customers 260 are customers of the financial institution 220 by virtue of them having credit or debit (e.g., demand deposit/checking) accounts with the financial institution 220. The customers 260 use their bank cards, or other transaction devices 265, to make purchases or other transactions with the merchants 250. The POS computer systems 252 for a plurality of merchants 250 read the customers' transaction devices 252 and communicate information about each transaction to the transaction processing system 222 of the financial institution 220 via network 210. Some customers make transactions through other transaction systems 270, such as through ATMs, and these transaction systems 270 also send transaction information to the transaction processing system 222. Meanwhile, a user, which may be for example a merchant 250 or an employee of the financial institution 220, uses a graphical user interface provided by the user interface 234 of the community rewards apparatus 230 to create a community reward definition 239 for a particular community reward. In one example, the user defines the community 240 as a particular geographic area and defines community transactions as being any purchase transaction made by any customer of the financial institution 220 where either the customer lives in the particular geographic area or the merchant is located in the particular geographic area. In the illustrated embodiment, the specified community 240 includes any transactions between a customer and Merchant A 250A, including a transaction between Merchant A 250A and Customer C 260C who lives outside of the geographic area. The specified community 240 also includes any transactions between a customer and Merchant C 250C. The specified community 240 also includes any transactions between a Customer A 260A and any other merchant, regardless of where the merchant is located. However, the community 240 does not include transactions made between customers residing outside the geographic area and merchants located outside the geographic area. In this embodiment, the community rewards apparatus 230 receives transaction data from the transaction processing system 222 using its network interface 233. The community rewards apparatus 230 then stores the transaction data 238 in the memory system 237. The community rewards apparatus 230 then uses the community reward definition 239 to identify the transactions in the transaction data 238 that are within the defined community 240. The processor 235, after making these identifications, aggregates some aspect of these community transactions according to the community reward definition 239 to obtain a community total. The processor 235 then compares the community total to a community threshold according to the community reward definition 239 to determine whether the community reward should be triggered. If the threshold is met by the community total, the communication interface 232 may be used to notify a person or device that the community reward should be provided.

Each flow chart provided herein is divided into blocks illustrating actions or events that are undertaken by a financial institution (e.g., a bank, credit card company, payment network company, and/or the like), a merchant, a third party, and/or a customer as described herein. Each flow chart represents an exemplary embodiment of the invention. It will be understood that, unless clearly stated herein otherwise, in other embodiments of the invention some or all of the actions or events may be performed in a different order or simultaneously. Likewise, in some embodiments of the invention, one or more of the actions or events may be removed, optional, added, and/or combined with one or more other actions or events.

In one embodiment, a community rewards program is any product, service, or program offered by an entity to a user to allow the user or another entity to create, receive, view, monitor, and/or manipulate community rewards and/or reward options. As described above, in some embodiments, the community reward is a discount for a future purchase transaction, a rebate, a coupon, a gift card, a cash amount, a check, a discount code, an account credit, a vacation package, a free product or service, a reduced interest rate, approval of a financial product, a donation to an organization or non-profit, a sponsorship of an event, a donation to a governmental organization or project, an investment into a business or project, and/or any other type of award or combination of awards. In this regard, in some embodiments, the community rewards program is a promotional tool (e.g., a product, service, program, etc.) offered by a financial institution, merchant, or other entity.

Additionally, it should be noted that the community rewards can be a reward associated with any entity, such as a financial institution, a cell phone service provider/store, a utilities provider, club memberships, retail stores, stores providing rental services/products, or any other entity with which the user interacts. For example, in one embodiment, a national hardware store could issue rewards to customers who purchase products or services in a particular city and who pay with a preferred credit card. The reward may be paid to the customers of that city in the form of a donation to that city. In another embodiment, the community rewards program can be a program run by a financial institution that issues a reward when those in a community spend a predefined amount of transactions in the community.

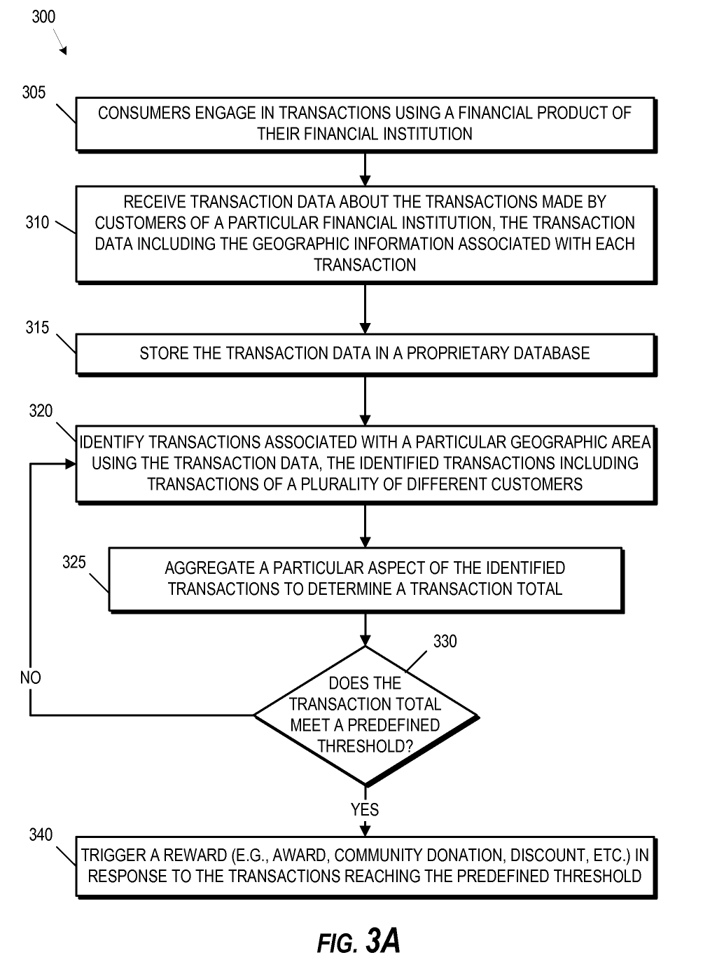

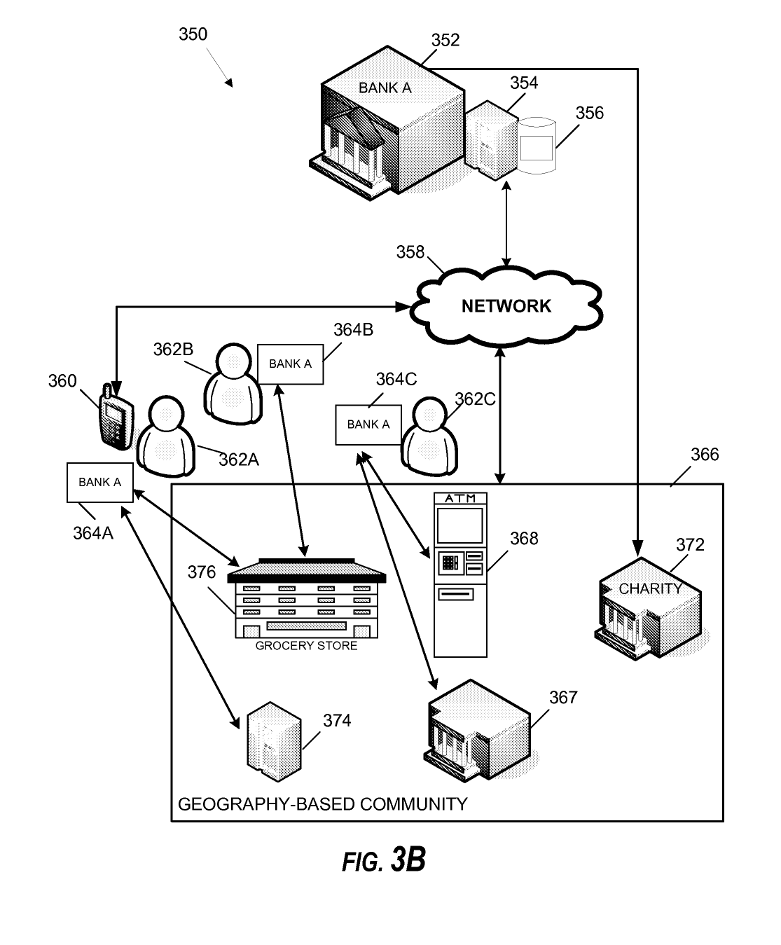

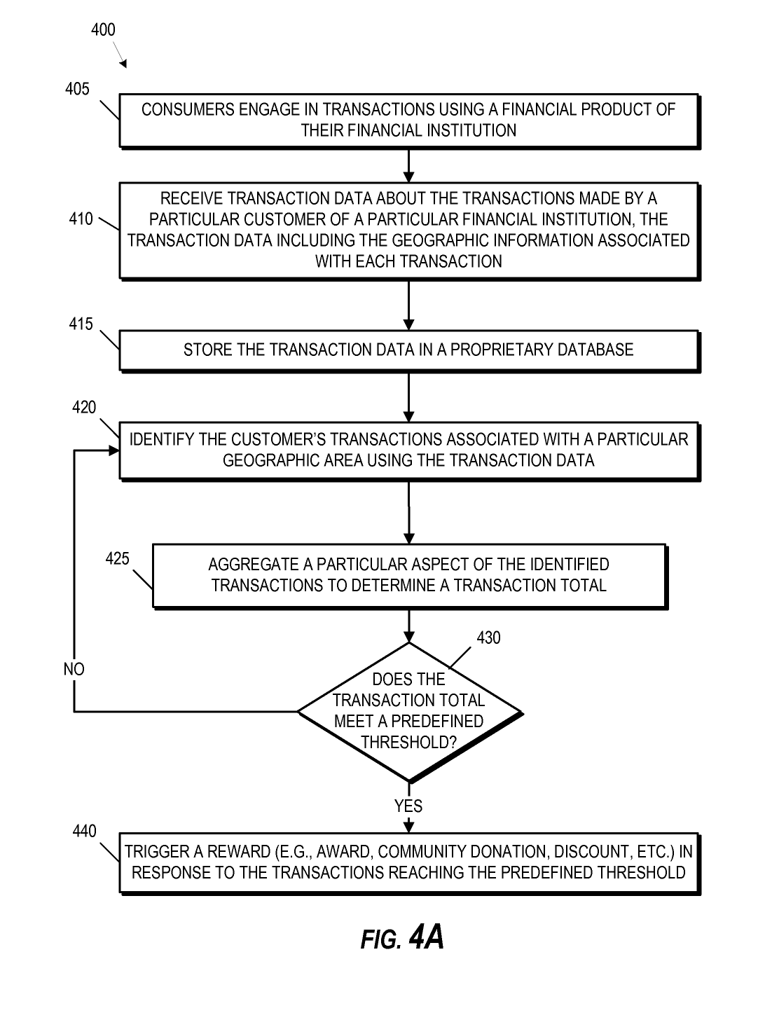

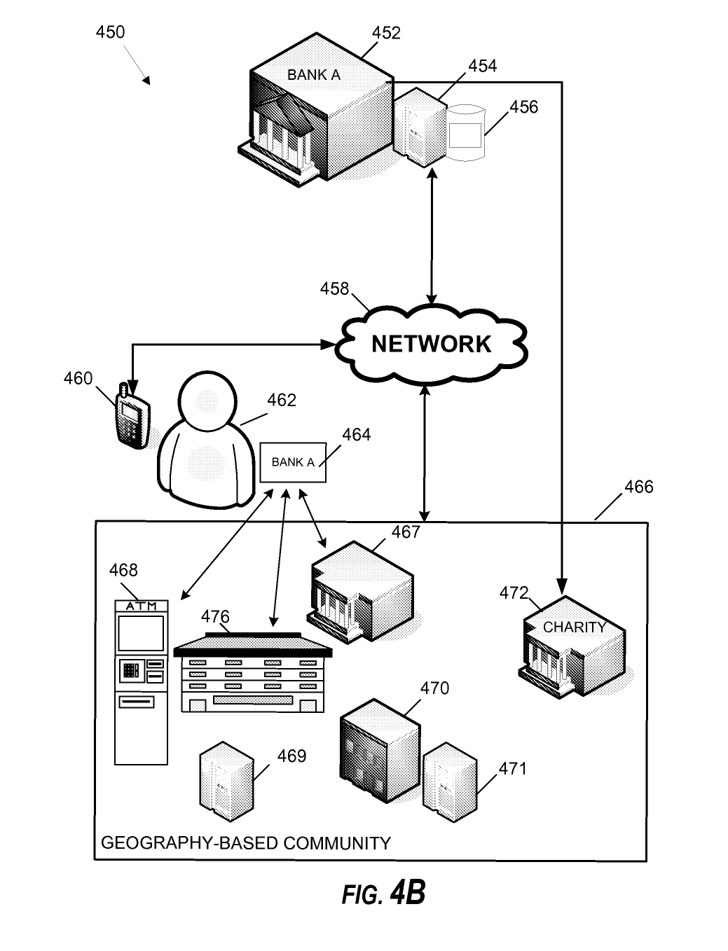

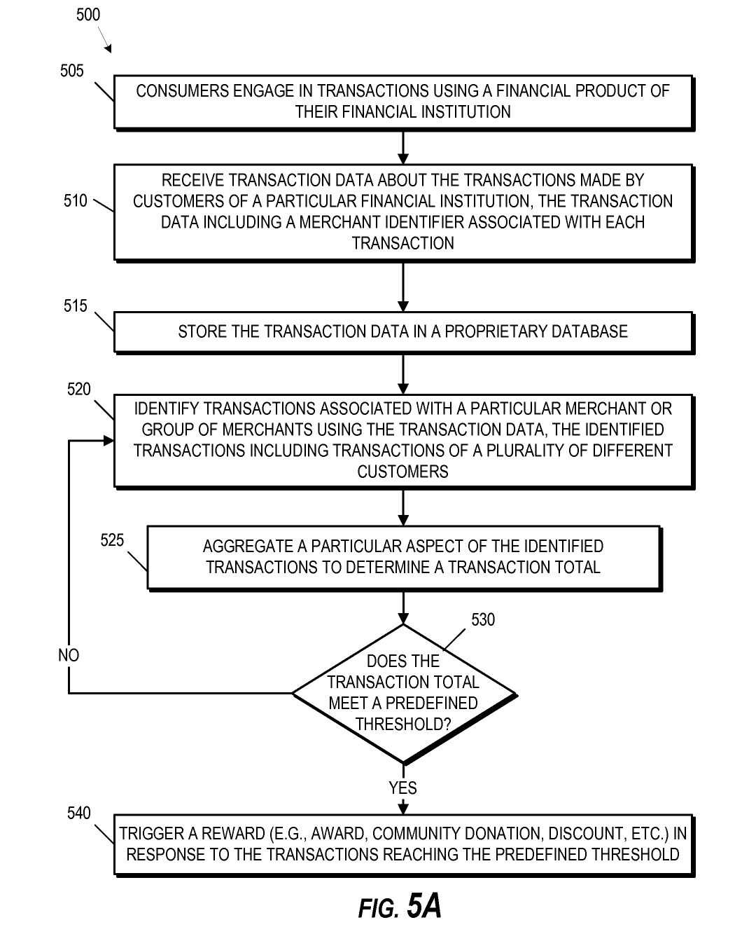

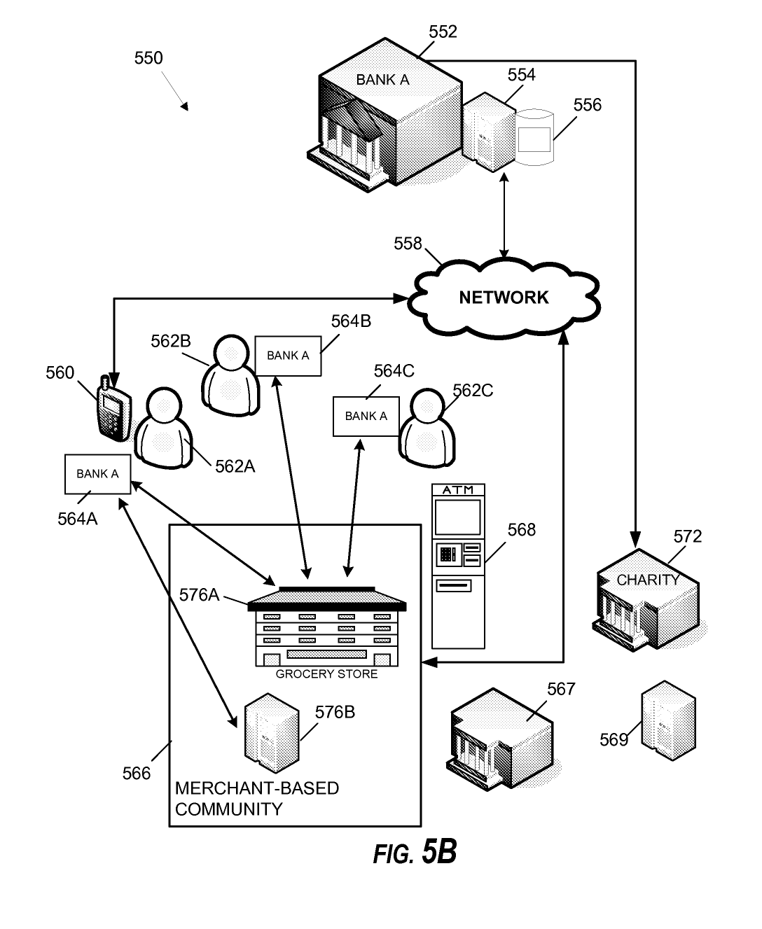

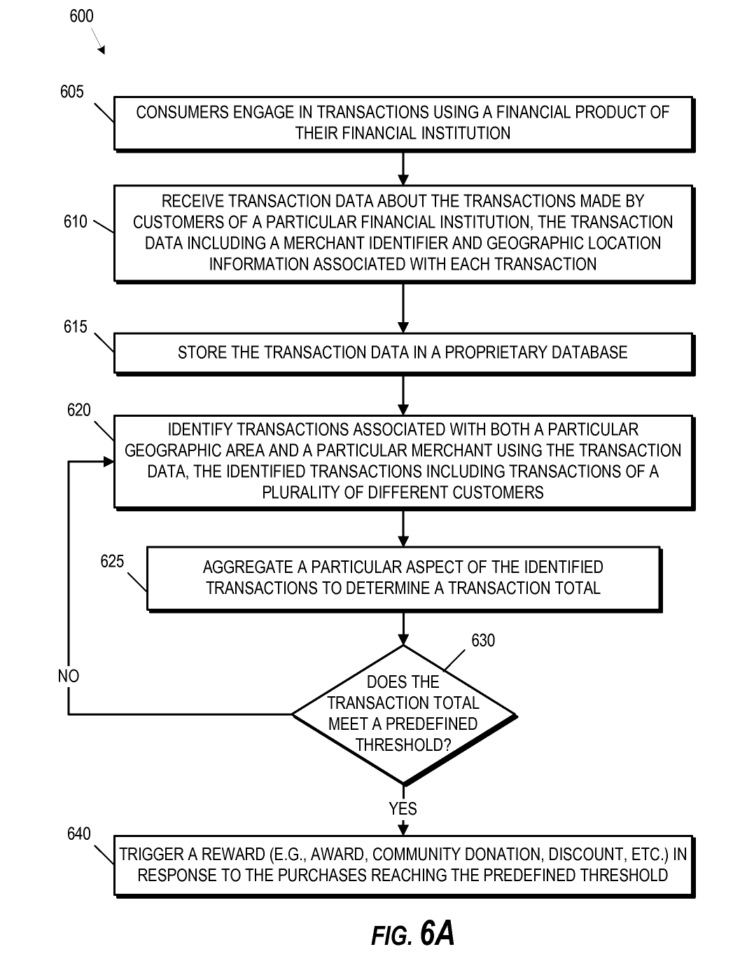

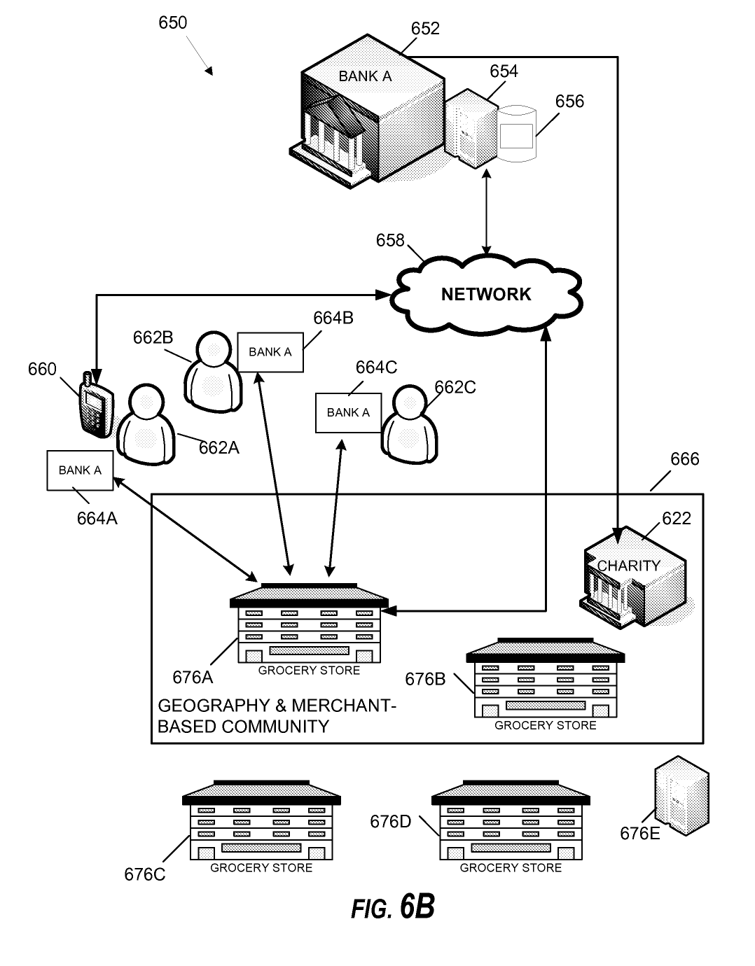

FIGS. 3A-6B illustrate example embodiments of the community rewards methods and systems described with regard to FIGS. 1 and 2. Specifically, FIGS. 3A and 3B illustrate a method and system for managing a geography-based community rewards program where qualifying transactions include the transactions of a plurality of different customers. FIGS. 4A and 4B illustrate a method and system for managing a geography-based community rewards program where qualifying transactions include the transactions of a single customer. FIGS. 5A and 5B illustrate a method and system for managing a merchant-based community rewards program where qualifying transactions include the transactions of a plurality of different customers. FIGS. 6A and 6B illustrate a method and system for managing a geography and merchant-based community rewards program where qualifying transactions include the transactions of a plurality of different customers. FIGS. 3A-6B are provided to illustrate only some example embodiments of a community rewards program and other embodiments of a community rewards program are described elsewhere herein and/or will be apparent to one of ordinary skill in the art in view of this disclosure. Furthermore, embodiments of the invention described herein may be combined with other embodiments of the invention described herein to form yet other embodiments of the invention.

Referring now to FIG. 3A, a flow chart is provided illustrating a geography-based community rewards process 300 in accordance with an exemplary embodiment of the invention. As represented by block 305, consumers regularly engage in transactions using a financial product, such as a credit or checking account, offered by their financial institution. The consumers can be individuals, groups, organizations, account holders, or any persons authorized to use the financial product or set preferences for that financial product. The transactions may include, for example, purchases including payment for a product by a credit card, debit card, check, direct withdrawal, or any other form of payment associated with the customer and the financial institution. The transactions may also include withdrawals, deposits, return, transfers, credits, loans, and/or any other financial transaction. It should be understood that the term “product” as used herein may be any good or service offered for sale by a merchant or other business.

As represented by block 310, transaction data associated with the particular financial institution's customers' transactions is received. For example, a financial institution receives transaction data about its customers' transactions via one or more transaction processing systems that process electronic transactions made via, for example, bank card systems, online e-commerce systems, online banking systems, telephone commerce systems, telephone banking systems, ATM systems, and/or other electronic financial transaction systems. The transaction data may include information about bank card transactions, ATM withdrawals or deposits, automatic withdrawals, financial instrument transactions, and other financial transactions whether in document, electronic, or other form. It should be understood that the methods described below can apply to data other than purchase transaction data, including data associated with charity donations or gifts.

As further stated in block 310, the transaction data includes geographic information associated with each transaction. The geographic information may be information about the location of the transaction, the location of the customer, the location of the merchant, and/or the location of the financial institution or a branch thereof. The location of the transaction may be the location of the brick-and-mortar store where the transaction was made, the location of the customer when the transaction was made, the location of the customer's computing device when the transaction was made (e.g., for online or other e-commerce type transactions), and/or the like. The location of the customer may be the location where the customer lives, the location where the customer works, the location where the customer is when the transaction is made, and/or the like. The location of the merchant may be the location of the merchant's retail location where the transaction was made, the location of the merchant's headquarters, the location of the merchant's web servers, the location of the computing device used to access the merchant's e-commerce platform, and/or the like. For example, in one embodiment the authorization request received to authorize a transaction includes a merchant code that can be used to identify the geographic location of the point-of-sale. Geographic location information may include, for example, a street, borough, village, town, city, county, state, country, region, zip code, area code, neighborhood, coordinate, and/or the like.

In some embodiments of the invention, the transaction data is sent to a financial institution (or other party) by a business, an organization, an agent, or any entity involved in the transaction. The transaction data is received through a network connection, electrical, auditory, written, or other mechanism for receiving data. In some embodiments, the entity sending the transaction data is a third party such as a billing or payment service provider. It should be understood that the financial institution may receive the transaction data in any manner, whether the data is received from other financial institutions, from an individual, from a merchant, from a customer, from a POS computer system, or from any other entity. As represented by block 315, the transaction data is stored in a proprietary database of a financial institution, a business, a group of businesses, or other organization.

As represented by block 320, a computing device then uses the transaction data stored in the database to identify any transactions associated with a predefined geographic area associate with a particular reward. In the illustrated embodiment, the identified transactions include transactions of a plurality of different customers. For example, in one embodiment of the invention, the computing device searches the transaction data for the particular financial institution and identifies all purchases made by a customer of the financial institution within the last month where the purchase was made at a merchant located within a particular county. In one embodiment, the predefined geographic area used to define the community is a subset (i.e., less than the whole) of a geographic area represented by the transaction data generally or is a subset of the geographic footprint of the financial institution. For example, the transaction data may include transactions made at various locations all across a particular country, but the predefined geographic area used to define the community may be some smaller portion of that country. In another example, the financial institution serves ten different states and the predefined geographic area used to define the community is some area within, but less than, the area represented by the ten states (e.g., the predefined geographic area may be one of the ten states, a portion of one of the ten states, a region overlapping several but not all states, etc.). In some embodiments of a geography-based community rewards program, the community is defined by one or more other factors in addition to geography.

As represented by block 325, a particular aspect of the transactions identified in step 320 are then aggregated to determine a transaction total (i.e., a “community total”). The particular aspect of the identified transactions may be, for example, the number or the value of the transactions. The transaction total may be, for example, the total number of transactions identified in step 320, the total value of the transactions identified in step 320, the average value of the transaction identified in step 320, the frequency of the transactions identified in step 320, the percentage of the total transactions represented by the transaction data of step 310 that are transactions identified in step 320, and/or the like.

As represented by block 330, a determination is made as to whether the transactions meets a predefined threshold. In the illustrated embodiment, the transaction total from step 325 is compared to a transaction threshold to determine whether the transaction total meets the threshold by being equal to, greater than, less than, greater than or equal to, or less than or equal to the threshold, as the case may be. The transaction threshold may be a predefined value (e.g., dollar amount), number, percentage, and/or the like based on the type of transaction total. For example, where the community's transaction total from step 325 reflects the total value of the transactions identified in step 320, then the predefined transaction threshold may be a dollar amount and a computer may determine that the community's transaction total meets the transaction threshold if the transaction total is greater than or equal to the dollar amount. In another example, where the community's transaction total from step 325 reflects the total number of purchases identified in step 320, then the predefined transaction threshold may be a particular number and a computer may determine that the community's transaction total meets the transaction threshold if the transaction total is greater than or equal to the particular number.

If the transaction total does not meet the predefined transaction threshold, then the process returns to step 320 and the system continues to track transactions associated with the predefined geographic area and repeats steps 320, 325, and 330 until either the community reward expires of the transaction threshold is met. However, in other embodiments, the tracking of the transactions associated with a particular geographic location is suspended or terminated if the predefined threshold is not met. For example, if the predefined threshold is dependent on reaching a certain goal by a specific date and the system only conducts the determination of step 330 on that specific date, then failure to meet the threshold by the specific date may result in termination of the transaction tracking for that particular reward.

As represented by block 340, when the transaction total does meet the predefined transaction threshold, the system triggers a reward in response to the transactions meeting the predefined threshold. As disclosed above, the reward is some sort of award, such as a discount for a future purchase transaction, a rebate, a coupon, a gift card, a cash amount, a check, a discount code, an account credit, a vacation package, a free product or service, a donation to an organization, environmentally-responsible contributions, re-investments into the community, or any other type of award. For example, the reward may be a donation to a local charity, a research facility, a public school, a hospital, a volunteer organization, or a park that serves, is located in, or is otherwise associated with the predefined geographic area used in step 320. The reward may be triggered by the system automatically notifying an entity that continues the process of providing the reward, automatically providing the reward to an entity, automatically prompting customers to select or vote on the reward and/or reward beneficiary, initiating a reward giving process, automatically transferring money or credit into an account, automatically reducing an interest rate, automatically sending a coupon or other offer to a person, either electronically or otherwise, and/or any other method associated with providing a reward.

FIG. 3B is a block diagram illustrating an example of a community reward system 350 configured to perform the method of FIG. 3A in accordance with some embodiments of the invention. The system 350 includes a bank server 354 communicably coupled to the computer systems of one or more merchants, banking systems, and other transaction systems via a network 358. Bank server 354 is a computer system operated by or located at a bank 352 that is implementing an embodiment of the present invention. The bank 352 is a financial institution that issues bank cards 364A, 364B, and 364C to different customers 362A, 362B, and 362C, respectively. The bank 352 may be a single bank or a group of banks having one or more locations inside or outside a community 366. The community 366 is defined by a geographical area. In the illustrated embodiment, qualifying community transactions for a community reward are any transactions made by a customer of the bank 352 where the transaction is made within the predefined geographic area of the predefined community 366. In the illustrated embodiment, the geography-based community 366 includes an ATM 368, a store 376, a business 367, an e-commerce server 374, and a charity 372.

The bank server 354 may be any type of computer or other device that is capable of communication with network 358. In one embodiment, the bank server 354 includes hardware, a database 356, a processor, and at least one software application. The network 358 can be any type of network or communication device that allows bank server 354 to communicate with the customer's computer system 360 and various transactions systems and member located in the community 366. In some embodiments, the network 358 includes the Internet, a private network, cellular network, wireless network, and/or other network. In some embodiments, the customer computer system 360 includes at least one software application for implementing one or more functions described herein. The computer system 360 may be a computer, a PDA, a smart phone, or any other device that can be coupled to the network 358. In some embodiments, ATM 368 and merchant store 376 include a card reader that reads account information from the customers' bank cards 364, or any other type of financial device that can be used to purchase an item. For example, in the illustration, customer 362A purchases products or services at store 376 by swiping bank card 364A through a card reader of a POS computer system located in the store 376. E-commerce server 374 may be any type of computer or other device that is capable of communication with network 358 and the customer's computing device 360 and configured to process transactions online for the customer 362A. In some embodiments, the e-commerce server 374 transfers transaction data or other information to bank server 354 via the network 358. The charity 372 is also located in the geography-defined community 366 and may include a computer system in communication with the bank server 354 via the network 358. In some embodiments, charity 522 receives rewards from the bank server 354 or a merchant's server via the network 358.

The method 300 described above with respect to FIG. 3A may be embodied in or performed by the hardware and software of the bank server 354 and/or one or more of the merchant computer systems, customer computer systems, charity computer systems, and/or other transaction systems. Information may be accessible by a customer 362A on customer computing device 360 (e.g., smart phone, PDA, etc.) via the network 358. In some embodiments, the bank server 354 stores the transaction data of its customers' transactions into a database 356.

For example, in one exemplary embodiment of the invention, the bank 352 is an international bank serving customers around the world. In an effort to increase community involvement in a particular city, increase awareness in the city of the bank's community involvement, and attract new customers to the bank within the city, the bank offers a promotion where the bank agrees to donate $100,000 (i.e., the reward) to charitable organizations within the city (i.e., the geography-based community 366) if the transactions made within the city with a bank-issued card 364 exceed 30,000 (i.e., the transaction threshold) during the current month. The bank 352 receives transaction data about transactions around the world and identifies, from these transactions, all transactions made with a bank-issued card 364 in the particular city. If 30,000 transactions are made within the city using a bank-issued card 354, then the bank pays the $100,000 reward to one or more charities 372 located within the city. In some embodiments, the customers 362 located in the city get to vote on the charity/charities 372 that should receive the reward.

FIG. 4A provides a flow chart illustrating another example of a geography-based community rewards process 400 where only the qualifying transactions of a single customer are aggregated, in accordance with an exemplary embodiment of the invention. Many of the steps in this process 400 are similar to those described above with respect to FIGS. 1 and/or 3A. As such, many of the details or alternative embodiments of such steps are not repeated for this figure for the sake of conciseness. However, it will be apparent that many of the statements made with reference to the foregoing embodiments may apply equally to some of the embodiments described hereinbelow.

As represented by block 405, consumers regularly engage in transactions using a financial product, such as a credit or checking account, offered by their financial institution. As represented by block 410, transaction data associated with a particular customer of a particular financial institution is received. For example, in one embodiment, a financial institution receives transaction data about a particular customer's transactions via one or more transaction processing systems that process electronic transactions made via one or more electronic financial transaction systems. As further stated in block 410, the transaction data includes geographic information associated with each of the customer's transactions. As represented by block 415, the transaction data for the particular customer is then stored in a proprietary database of the financial institution, a business, a group of businesses, or other organization.

As represented by block 420, a computing device then uses the transaction data stored in the database to identify any of the particular customer's transactions that are associated with a predefined geographic area associate with a particular reward. In some embodiments of a geography-based community rewards program, the community is defined by one or more other factors in addition to geography.

As represented by block 425, a particular aspect of the transactions identified in step 420 are then aggregated to determine a transaction total (i.e., a “community total”) for the particular customer. The particular aspect of the identified transactions may be, for example, the number or the value of the transactions. The transaction total may be, for example, the total number of transactions identified in step 420, the total value of the transactions identified in step 420, the average value of the transaction identified in step 420, the frequency of the transactions identified in step 420, the percentage of the total transactions represented by the transaction data of step 410 that are transactions identified in step 420, and/or the like.

As represented by block 430, a determination is made as to whether the transactions meets a predefined threshold. In the illustrated embodiment, the transaction total from step 425 is compared to a transaction threshold to determine whether the transaction total meets the threshold by being equal to, greater than, less than, greater than or equal to, or less than or equal to the threshold, as the case may be. The transaction threshold may be a predefined value (e.g., dollar amount), number, percentage, and/or the like based on the type of transaction total.

If the customer's transaction total does not meet the predefined transaction threshold, then the process returns to step 420 and the system continues to track the customer's transactions associated with the predefined geographic area and repeats steps 420, 425, and 430 until either the community reward expires of the transaction threshold is met. However, in other embodiments, the tracking of the transactions associated with a particular geographic location is suspended or terminated if the predefined threshold is not met.

As represented by block 440, when the customer's transaction total does meet the predefined transaction threshold, the system triggers a reward in response to the transactions meeting the predefined threshold. As disclosed above, the reward is some sort of award, such as a discount for a future purchase transaction, a rebate, a coupon, a gift card, a cash amount, a check, a discount code, an account credit, a vacation package, a free product or service, a donation to an organization, environmentally-responsible contributions, re-investments into the community, or any other type of award. For example, the reward may be a donation to a local charity selected by the particular customer. In anther example, the reward is a rebate deposited into the customer's bank account on all transactions made by the customer during the next week using a bank-issued credit or debit card.

FIG. 4B is a block diagram illustrating an example of a community reward system 450 configured to perform the method of FIG. 4A in accordance with some embodiments of the invention. The system 450 includes a bank server 454 communicably coupled to the computer systems of one or more merchants, banking systems, and other transaction systems via a network 458. The bank server 454 is a computer system operated by or located at a bank 452 that is implementing an embodiment of the present invention. The bank 452 is a financial institution that issues one or more bank cards 464 (i.e., credit or debit cards or other transaction devices) to different a particular customer 462. The bank 452 may be a single bank or a group of banks having one or more locations inside or outside a community 466. The community 466 is defined at least in part by a geographical area. In the illustrated embodiment, qualifying community transactions for a community reward are any transactions made by the customer 462 where the transaction is made within the predefined geographic area of the predefined community 466 using a bank-issued card 464. In the illustrated embodiment, the geography-based community 466 includes an ATM 468, several stores 476, 467, and 470, several e-commerce servers 469 and 471, and a charity 472.

The method 400 described above with respect to FIG. 4A may be embodied in or performed by the hardware and software of the bank server 454 and/or one or more of the merchant computer systems, customer computer systems, charity computer systems, and/or other transaction systems. For example, in one exemplary embodiment of the invention, the bank 452 is an international bank serving customers around the world. In an effort to attract new customers to the bank and to the bank's merchant customers within a particular county, the bank offers a promotion where the bank agrees to provide a customer 462 with 5% cash back on all bank card purchases for six months (i.e., the reward) if the customer's transactions made within the county (i.e., the geography-based community 466) with a bank-issued card 464 exceed $5,000 (i.e., the transaction threshold) by a particular date. The bank 452 receives transaction data about transactions around the world and identifies, from these transactions, all transactions made by the customer 462 with a bank-issued card 464 in the particular county. If $5,000 in transactions is made within the county using a bank-issued card 454, then the bank provides the customer 462 5% cash back on bank card transactions for the next six months. In other embodiments of the invention, instead of cash back, the bank 452 makes a donation to a charity 472 located in the county and/or selected by the customer 462.

FIG. 5A provides a flow chart illustrating an example of a merchant-based community rewards process 500 in accordance with an exemplary embodiment of the invention. Many of the steps in this process 500 are similar to those described above with respect to FIGS. 1, 3A, and/or 4A. As such, many of the details or alternative embodiments of such steps are not repeated for this figure for the sake of conciseness. However, it will be apparent that many of the statements made with reference to the foregoing embodiments may apply equally to some of the embodiments described herein below.

As represented by block 505, consumers regularly engage in transactions using a financial product offered by their financial institution. As represented by block 510, transaction data associated with plurality of different customers of a particular financial institution is received. For example, in one embodiment, a financial institution receives transaction data about a plurality of its customers' transactions via one or more transaction processing systems that process electronic transactions made via one or more electronic financial transaction systems. As further stated in block 510, the transaction data includes merchant identifying information associated with each of the transactions. As represented by block 515, the transaction data is then stored in a proprietary database of the financial institution, a business, a group of businesses, or other organization.

As represented by block 520, a computing device then uses the transaction data stored in the database to identify any transactions that are associated with a particular merchant or group or merchants associated with a particular reward. As stated in block 520, in some embodiments, the identified transactions include transactions of a plurality of different customers. For example, the community may be defined as customers of a particular merchant or group of merchants. The merchant or group of merchants may be a particular retailer, wholesaler, manufacturer, distributor, store, chain, franchise, conglomerate, and/or any other business entity or organization. In some embodiments of a merchant-based community rewards program, the community is defined by one or more other factors in addition to a merchant or group of merchants.

As represented by block 525, a particular aspect of the transactions identified in step 520 are then aggregated to determine a transaction total (i.e., a “community total”) for community. The particular aspect of the identified transactions may be, for example, the number or the value of the transactions. The transaction total may be, for example, the total number of transactions identified in step 520, the total value of the transactions identified in step 520, the average value of the transaction identified in step 520, the frequency of the transactions identified in step 520, the percentage of the total transactions represented by the transaction data of step 510 that are transactions identified in step 520, and/or the like.

As represented by block 530, a determination is made as to whether the transactions meet a predefined threshold. In the illustrated embodiment, the transaction total from step 525 is compared to a transaction threshold to determine whether the transaction total meets the threshold by being equal to, greater than, less than, greater than or equal to, or less than or equal to the threshold, as the case may be. The transaction threshold may be a predefined value (e.g., dollar amount), number, percentage, and/or the like based on the type of transaction total.

If the transaction total does not meet the predefined transaction threshold, then the process returns to step 520 and the system continues to track the transactions associated with the predefined merchant or group of merchants and repeats steps 520, 525, and 530 until either the community reward expires of the transaction threshold is met. However, in other embodiments, the tracking of the transactions associated with a particular merchant is suspended or terminated if the predefined threshold is not met.

As represented by block 540, when the transaction total does meet the predefined transaction threshold, the system triggers a reward in response to the transactions meeting the predefined threshold. As disclosed above, the reward is some sort of award, such as a discount for a future purchase transaction, a rebate, a coupon, a gift card, a cash amount, a check, a discount code, an account credit, a vacation package, a free product or service, a donation to an organization, environmentally-responsible contributions, re-investments into the community, or any other type of award. For example, the reward may be a donation by the merchant or group of merchants to a local charity. In anther example, the reward is a discount on future purchases made by customers of the financial institution at the merchant or group of merchants.

FIG. 5B is a block diagram illustrating an example of a community reward system 550 configured to perform the method of FIG. 5A in accordance with some embodiments of the invention. The system 550 includes a bank server 554 communicably coupled to the computer systems of one or more merchants, banking systems, and other transaction systems via a network 558. The bank server 554 is a computer system operated by or located at a bank 552 that is implementing an embodiment of the present invention. The bank 552 is a financial institution that issues one or more bank cards 564A, 564B, and 564C (i.e., credit or debit cards or other transaction devices) to different customers 562A, 562B, and 562C, respectively. The bank 552 may be a single bank or a group of banks. The community 566 is defined at least in part by a merchant or group of merchants. In the illustrated embodiment, qualifying community transactions for a community reward are any purchases made by a bank customer 562 at a particular grocery store 576 using a bank-issued card 564. In the illustrated embodiment, the community 566 includes purchases made at the grocery store's brick-and-mortar store 576A as well as purchases made from the grocery store's online e-commerce server 576B. The community 566 does not include transactions made at an ATM 568, other stores 567, or other e-commerce servers 569.

The method 500 described above with respect to FIG. 5A may be embodied in or performed by the hardware and software of the bank server 554 and/or one or more of the merchant computer systems, customer computer systems, charity computer systems, and/or other transaction systems. For example, in one exemplary embodiment of the invention, the bank 552 is an international bank serving customers around the world. In an effort to help businesses attract new customers, the bank provides a system whereby a merchant can create a community rewards-type promotion where the merchant agrees to provide the bank's customers 562 with discounts (i.e., the reward) if the bank's customers make a certain number or value purchases with a bank-issued card 564 by a particular date. The bank 552 receives transaction data about transactions around the world and identifies, from these transactions, all purchases made by its customer 562 with a bank-issued card 564 at the particular merchant 576. When the purchases reach the purchase threshold set by the merchant 576, the bank 552 notifies the merchant that the discounts should be made available to the bank's customers 562. In some embodiments, the bank 562 also manages the discounts by having them applied automatically whenever a customer 562 uses a bank-issued payment device 564 at the merchant 576. In some embodiments, the merchant provides the discount to all of its customers, while in other embodiments the merchant provides the discount only to the bank's customers 562 or only to the bank's customers 562 that also are customers of the merchant 576. In still other embodiments, the discount or other reward is only provided to those customers that engaged in transactions that helped meet the transaction threshold. In other embodiments of the invention, instead of a discount, the bank 552 and/or the merchant 576 makes a donation to a charity 572.

FIG. 6A provides a flow chart illustrating an example of a geography and merchant-based community rewards process 600 in accordance with an exemplary embodiment of the invention. Many of the steps in this process 600 are similar to those described above with respect to FIGS. 1, 3A, 4A, and/or 5A. As such, many of the details or alternative embodiments of such steps are not repeated for this figure for the sake of conciseness. However, it will be apparent that many of the statements made with reference to the foregoing embodiments may apply equally to some of the embodiments described herein below.

As represented by block 605, consumers regularly engage in transactions using a financial product offered by their financial institution. As represented by block 610, transaction data associated with a plurality of different customers of a particular financial institution is received. For example, in one embodiment, a financial institution receives transaction data about a plurality of its customers' transactions via one or more transaction processing systems that process electronic transactions made via one or more electronic financial transaction systems. As further stated in block 610, the transaction data includes, for each transaction, merchant identifying information as well as information identifying a geographic location associated with each transactions. As represented by block 615, the transaction data is then stored in a proprietary database of the financial institution, a business, a group of businesses, or other organization.

As represented by block 620, a computing device then uses the transaction data stored in the database to identify any transactions that are associated with both a particular geographic area and a particular merchant or group or merchants. As stated in block 620, in some embodiments, the identified transactions include transactions of a plurality of different customers. For example, the community may be defined as customers of a particular merchant or group of merchants located in a particular geographic area. The merchant or group of merchants may be a particular retailer, wholesaler, manufacturer, distributor, store, chain, franchise, conglomerate, and/or any other business entity or organization. In some embodiments of a merchant-based community rewards program, the community is defined by one or more other factors in addition to a merchant or group of merchants. The geographic area specification for the community may require that the transaction occur in the predefined geographic area, that the customer reside in the predefined geographic area, that the merchant facility at which the transaction was made resides in the predefined geographic area, and/or the like.

As represented by block 625, a particular aspect of the transactions identified in step 620 are then aggregated to determine a transaction total (i.e., a “community total”) for community. The particular aspect of the identified transactions may be, for example, the number or the value of the transactions. The transaction total may be, for example, the total number of transactions identified in step 620, the total value of the transactions identified in step 620, the average value of the transaction identified in step 620, the frequency of the transactions identified in step 620, the percentage of the total transactions represented by the transaction data of step 610 that are transactions identified in step 620, and/or the like.

As represented by block 630, a determination is made as to whether the transactions meet a predefined threshold. In the illustrated embodiment, the transaction total from step 625 is compared to a transaction threshold to determine whether the transaction total meets the threshold by being equal to, greater than, less than, greater than or equal to, or less than or equal to the threshold, as the case may be. The transaction threshold may be a predefined value (e.g., dollar amount), number, percentage, and/or the like based on the type of transaction total.

If the transaction total does not meet the predefined transaction threshold, then the process returns to step 620 and the system continues to track the transactions associated with the predefined merchant or group of merchants and the geographic area and then repeats steps 620, 625, and 630 until either the community reward expires of the transaction threshold is met. However, in other embodiments, the tracking of the transactions associated with a particular geographic location and merchant is suspended or terminated if the predefined threshold is not met.

As represented by block 640, when the transaction total does meet the predefined transaction threshold, the system triggers a reward in response to the transactions meeting the predefined threshold. As disclosed above, the reward is some sort of award, such as a discount for a future purchase transaction, a rebate, a coupon, a gift card, a cash amount, a check, a discount code, an account credit, a vacation package, a free product or service, a donation to an organization, environmentally-responsible contributions, re-investments into the community, or any other type of award. For example, the reward may be a donation made jointly by the bank and the merchant to a charity located within the predefined geographic area. In anther example, the reward is a discount on future purchases made by customers of the financial institution at the merchant or group of merchants.

FIG. 6B is a block diagram illustrating an example of a community reward system 650 configured to perform the method of FIG. 6A in accordance with some embodiments of the invention. The system 650 includes a bank server 654 communicably coupled to the computer systems of one or more merchants, banking systems, and other transaction systems via a network 658. The bank server 654 is a computer system operated by or located at a bank 652 that is implementing an embodiment of the present invention. The bank 652 is a financial institution that issues one or more bank cards 664A, 664B, and 664C (i.e., credit or debit cards or other transaction devices) to different customers 662A, 662B, and 662C, respectively. The bank 652 may be a single bank or a group of banks The community 666 is defined at least in part by a merchant or group of merchants, as well as by a predefined geographic area. In the illustrated embodiment, qualifying community transactions for a community reward are any purchases made by a bank customer 662 at a particular grocery store 676 using a bank-issued card 664, where the grocery store 676 is located within a predefined geographic area. In the illustrated embodiment, the community 666 includes purchases made at the grocery store's brick-and-mortar stores 676A and 676B because these two stores reside within the particular geographic area (e.g., town, zip code, city, county, state, region, and/or the like) but does not include transactions made at its other stores 676C and 676D located outside that geographic area and transactions made online using one or more e-commerce servers 676E.

The method 600 described above with respect to FIG. 6A may be embodied in or performed by the hardware and software of the bank server 654 and/or one or more of the merchant computer systems, customer computer systems, charity computer systems, and/or other transaction systems. For example, in one exemplary embodiment of the invention, the bank 652 is an international bank serving customers around the world. In an effort to help businesses attract new customers and in an effort to itself be more involved in local communities, the bank provides a system whereby a community reward-type promotion can be created where, for example, the bank 652 and a merchant 676 can join together and provide a donation (i.e., the reward) to a charity 622 in particular geographic community if the bank's customers 664 located in that geographic area work together to make a certain number or value of purchases from a particular merchant in a within a particular time period. The bank 652 receives transaction data about transactions around the world and identifies, from these transactions, all purchases made by its customers 662 located within a particular geographic area 666 using a bank-issued card 664 at the particular merchant 676. When the purchases reach the purchase threshold set by the bank 652 and/or the merchant 676, the bank 652 notifies the merchant that the reward should be made available to the charity 622. In some embodiments, instead of a donation, the reward is a discount at the merchant for customers in the predefined geographic area.

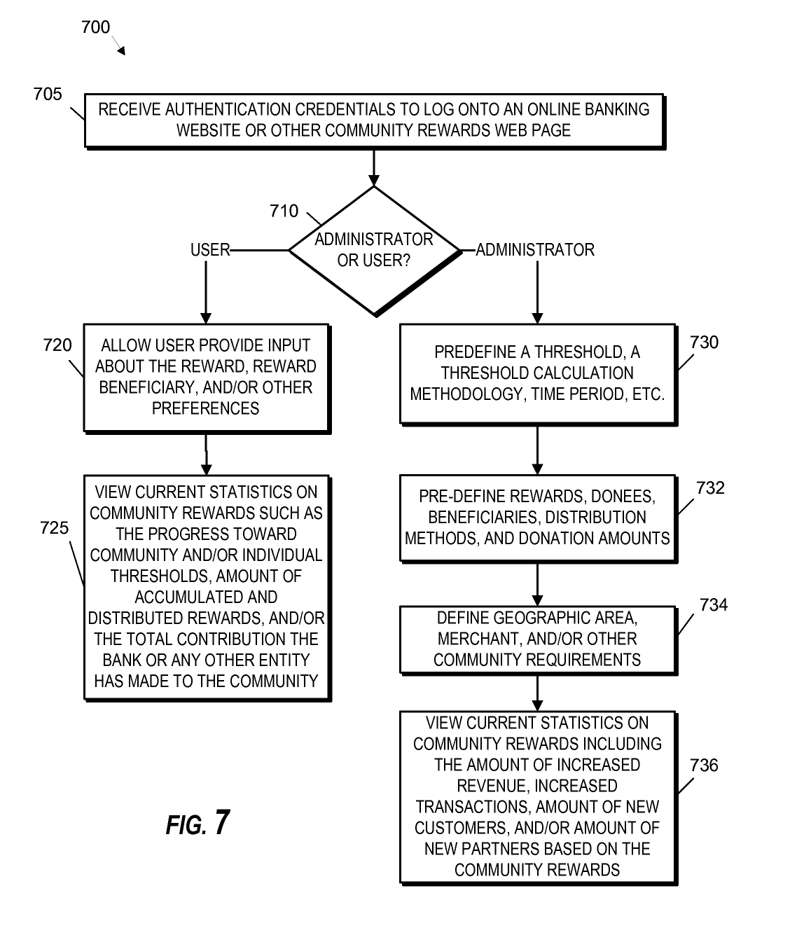

FIG. 7 provides a flow chart of a method 700 of viewing information about and setting preferences for a community rewards program in accordance with some embodiments of the invention. As represented by block 705, authentication credentials to log onto an online banking website or other community rewards website or portal is received. The authentication credentials may include, for example, an identification sequence and password. Further verification procedures such as answering a predetermined security question, typing in distorted text to verify human input, biometric scanning, and/or any other verification procedure may also be used.

As represented by block 710, a determination is made as to whether the authentication credentials are associated with a customer or an administrator. For example, in some embodiments of the invention the community rewards system is maintained by or otherwise associated with a particular financial institution. In such embodiments, a customer is a person having a financial account or other product with the financial institution, and an administrator is an employee of the financial institution or of a partnering merchant having authority to create and/or modify particular community rewards programs.

As represented by block 720, an authorized customer is, in some embodiments, allowed to provide input that may be used to define certain aspects of a community reward program such as the method of delivery of rewards, reward beneficiary, donation distribution, and/or other preferences. The customer preferences are received by a financial institution, a business, or any other entity operating the website at which the preferences are received. In some embodiments, the customer enters preferences after the threshold for receiving the reward is met, but before the reward is delivered. For example, a customer may be permitted to select an option of receiving a discount code by text and enter a cell phone number into a designated field on a gas station's community rewards website after reaching the predefined goal. In another example, a user may be permitted to vote for the charity or charities that should receive a particular donation after a threshold is met and it is clear that a donation will be paid. In other embodiments, a customer enters preferences before the threshold for receiving a reward is met. For example, a customer may be permitted to select the option of donating to the local volunteer fire department before making any purchases at geographic locations in the targeted geographic area.

In other embodiments, the customer can define the type of reward. For example, a customer could log onto a community rewards promotional website and select to receive a free cruise, a monthly discount, a gift card, or cash back from a list of options. In some embodiments, the user defines the reward recipient. For example the user could choose or vote on the organization to receive a charitable donation or could also choose to have a free product reward delivered to a friend.

In some embodiments, the customer can request a geographic area or community to be associated with. For example, if a customer is traveling on vacation and wants to participate in a community rewards program in their vacation destination, the customer may be permuted to register for the program in that particular destination. The customer may also be permitted to request, for example, to have their purchases associated the geographic area in which they reside or neighboring geographic areas.

As represented by block 725, in some embodiments of the invention, the customer can view current statistics on community rewards with which they are associated, including for example the progress toward community and/or individual thresholds, the amount of accumulated and distributed rewards, and/or the total contribution the bank or any other entity has made to the community to date. For example, a user may view progress made in reaching a predetermined level or the amount and type of rewards earned for the entire year. In one embodiment, this information is presented through the financial institution's online banking website when the customer accesses his or her online banking account.

As represented by block 730, the administrator may be permitted to define a threshold, threshold calculation methodology, time periods, and other preferences used for a particular community reward. For example, a business where purchases are made using accounts from a specific financial institution may also be a customer of that financial institution and may be permitted to enter preferences on an online banking web portal. In some embodiments, the administrator also enters the transaction data to be used in a threshold calculation. For example, a business may set a threshold calculation and enter the transaction data onto a secured webpage operated by a financial institution or some other provider of a community rewards system.

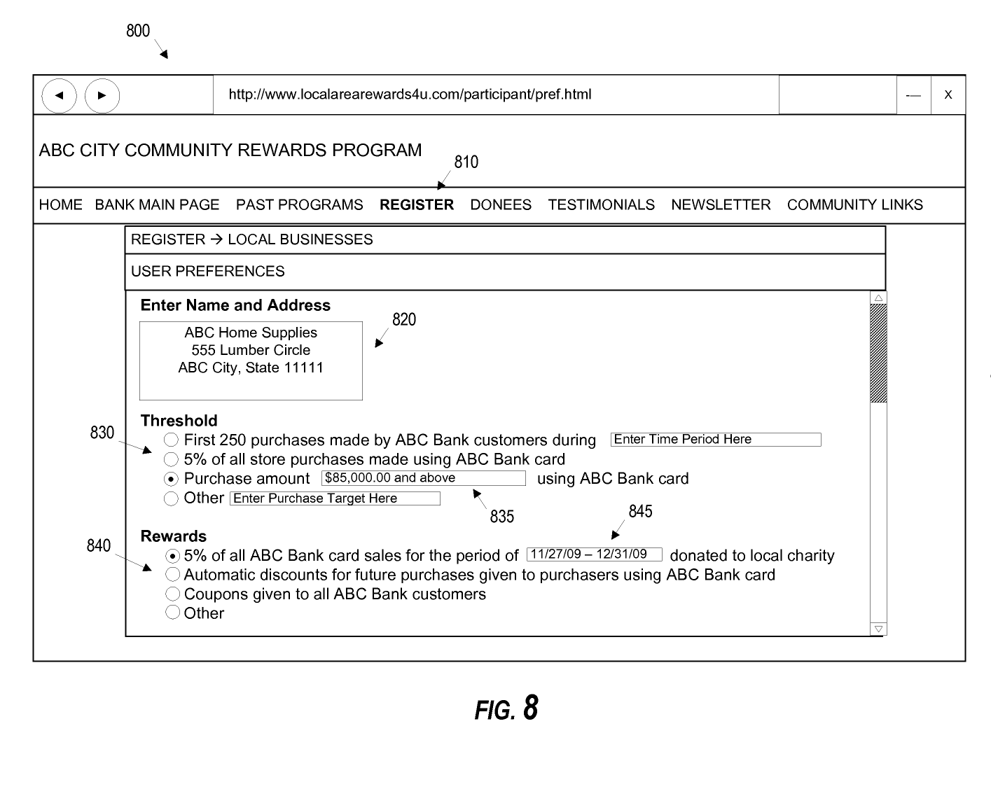

As represented by block 732, the administrator may also be permitted to define rewards, donees, reward beneficiaries, distribution methods, and/or donation amounts. An exemplary embodiment thereof is detailed later in FIGS. 8-12.

As represented by block 734, the administrator may further be permitted to define a geographic area, merchant, group of merchants, or other community for the a particular community reward. For example, an owner of a chain of stores may choose the cities in which its stores are located.

As represented by block of 736, the administrator may also be provided with views of current statistics on its individual or overall community reward programs including, for example, the amount of increased revenue during community rewards time periods, amount of increased transactions, amount of new customers, amount of new partners and/or the like. For example, a bank website may present to a group of businesses data regarding an increase in the number of bank customers who shop at the businesses so as a result of the community rewards program.

FIGS. 8-12 illustrate several example graphical user interfaces (GUIs) that may be provided, for example, in an online banking portal or other online community rewards management system. FIG. 8 illustrates an example of a GUI 800 where a user can set preferences by clicking on the “Register” link 810 on the tool bar located near the top of the interface. Upon selection of this link, the GUI of FIG. 8 is provided to the user. The GUI of FIG. 8 displays a set of fields for registering an entity into the community rewards program. The user enters the name and address of its business in the designated field 820. The user defines a threshold by clicking on the box next to the threshold option in the designated field 830. Once a threshold option has been designated, the user then types in the threshold criteria 835 if prompted. For example, the user enters the purchase amount of $85,000 for the purchase amount option. The user also defines a rewards option by clicking on the box next to the reward option in the designated field 840. For some options, the user may be prompted to enter certain criteria 845.

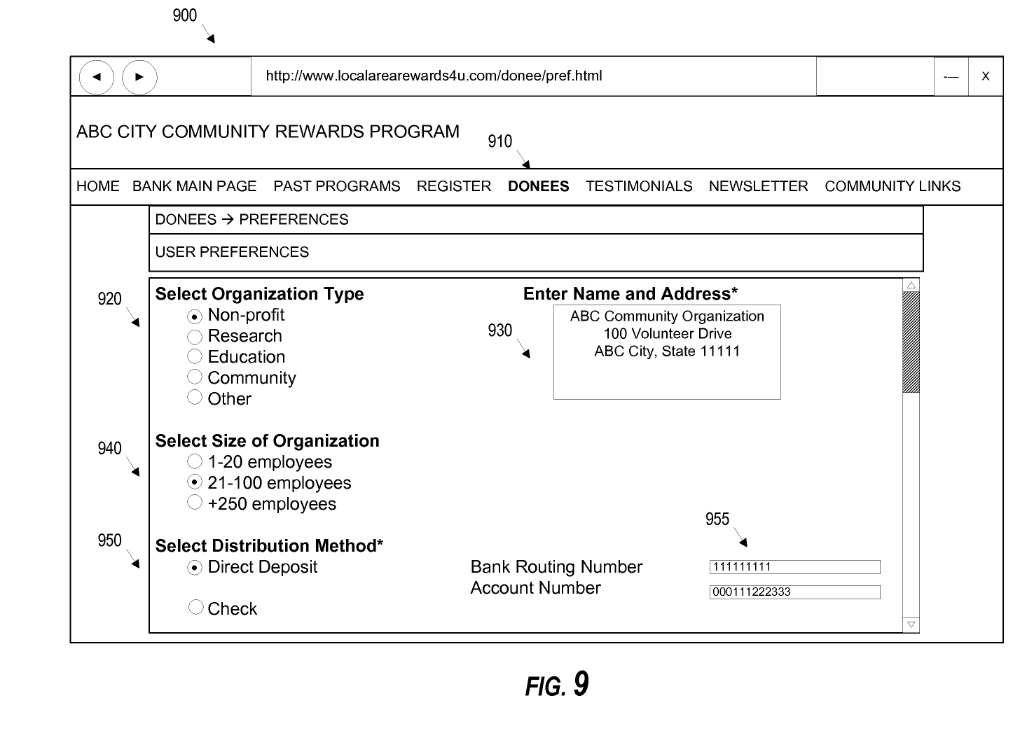

FIG. 9 illustrates another example of a GUI 900 shows a community rewards website where a donee sets preferences by clicking on the “Donee” link 910 on the tool bar located near the top of the GUI. Upon selection of that link 910, the GUI 900 is opened. The GUI 900 displays a set of fields for setting preferences for a donation recipient. The user defines the organization type by clicking on the box next to the type option 920. Once the option has been designated, the user then types in its name and address in the appropriate field 930. The user may also click on a box designating the number of employees of the donation recipient in the appropriate field 940. Furthermore, the user may select a distribution method for receiving the donation by clicking on an option 950. For example, the user may be able to select that the donation be received by direct deposit and enter the bank account information in the designated fields 955.

The online community rewards program GUIs may also include other options or features in the interface not shown, such as viewing past programs and testimonials and connecting users to community links.

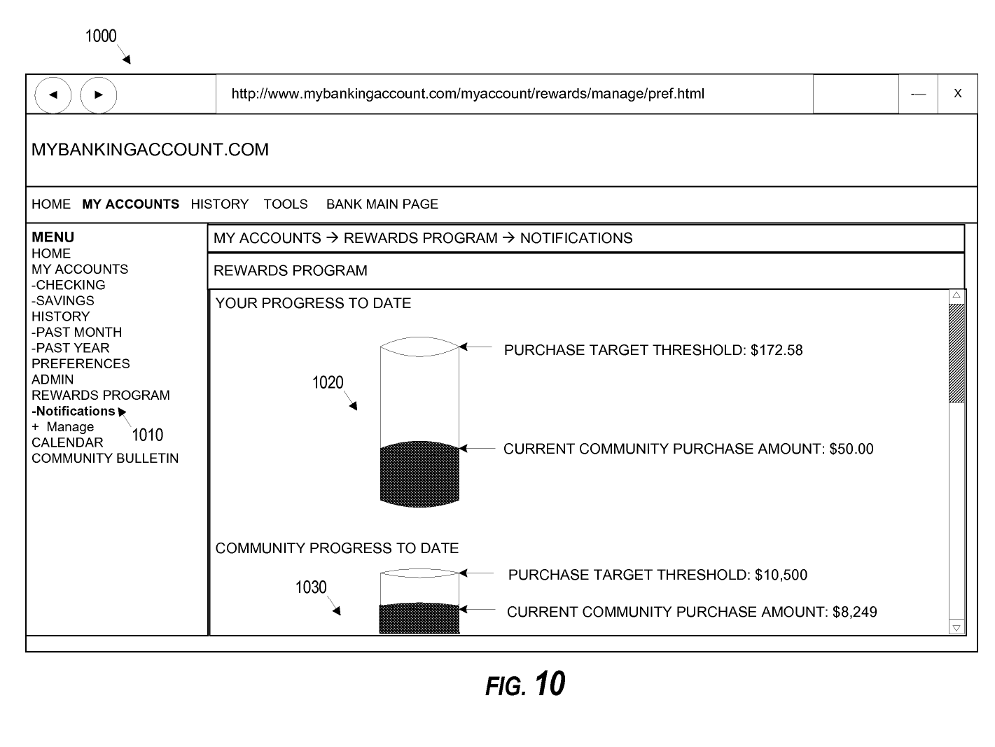

FIGS. 10-12 illustrate GUIs of online banking system where the bank manages a community rewards program and provides information about a customer's involvement in the community rewards program. In one embodiment, as illustrated in FIG. 10, the bank account owner can view community rewards progress updates by clicking on “Notifications” 1010 under “Rewards Program” on the left hand side of the GUI. Upon clicking the “Notifications” link 1010, a GUI 1000 is displayed presenting the account owner's progress 1020 for any individual community reward programs and the community's progress 1030 for any community-wide reward programs toward reaching the respective thresholds. As illustrated, this may be accomplished using a graphical, textual, and numerical representation. This status update is represented, in one embodiment, by cylindrical figures that are partially shaded to indicate the amount of progress made in reaching the threshold, but the status update can be in any format. The status update information was obtained in accordance with methods described herein with respect to one or more of the flow charts.

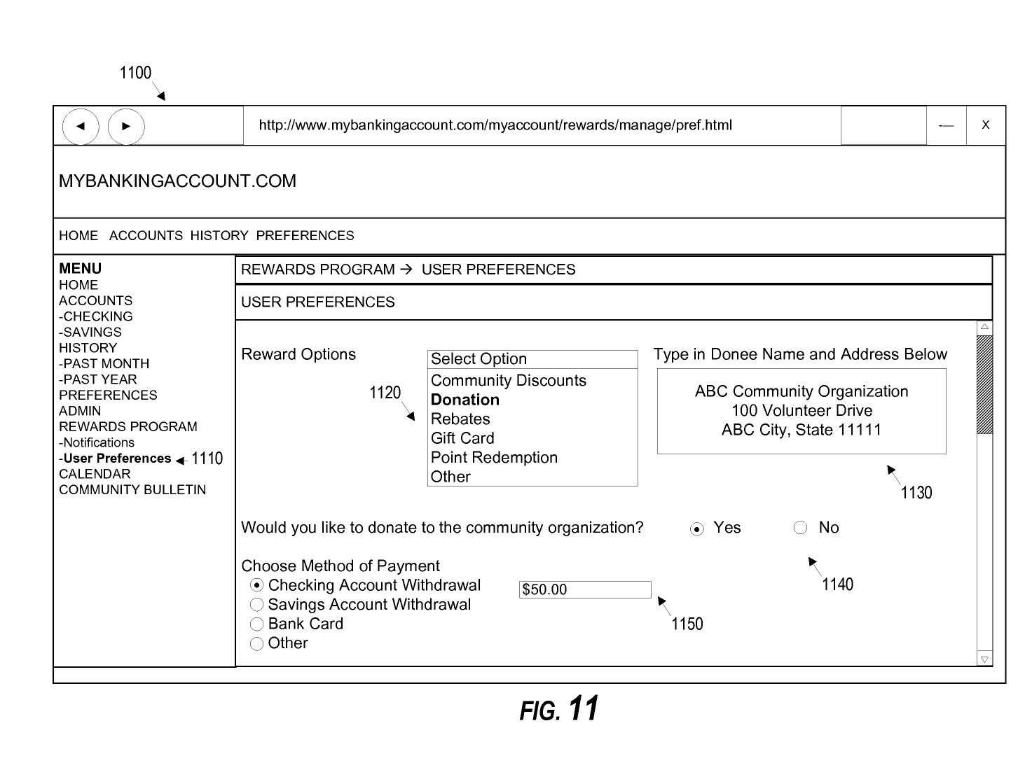

In some embodiments of the invention, user preferences can be set using an online banking system such as that illustrated in FIG. 11. The user can view preferences by clicking on “User Preferences” 1110 under “Rewards Program.” The selection opens up a new GUI 1100 displaying user preferences fields. The user may select a reward option by clicking on one of the options in the “select option” list 1120. Upon selecting “Donation,” for example, the user may then be able to designate the donation recipient by typing in the name and address of the recipient 1130 or by selecting from a group of pre-approved organizations. The user may also choose to donate to the donation recipient by clicking on the appropriate response 1140 and may also designate the method and amount of payment in the appropriate fields 1150.

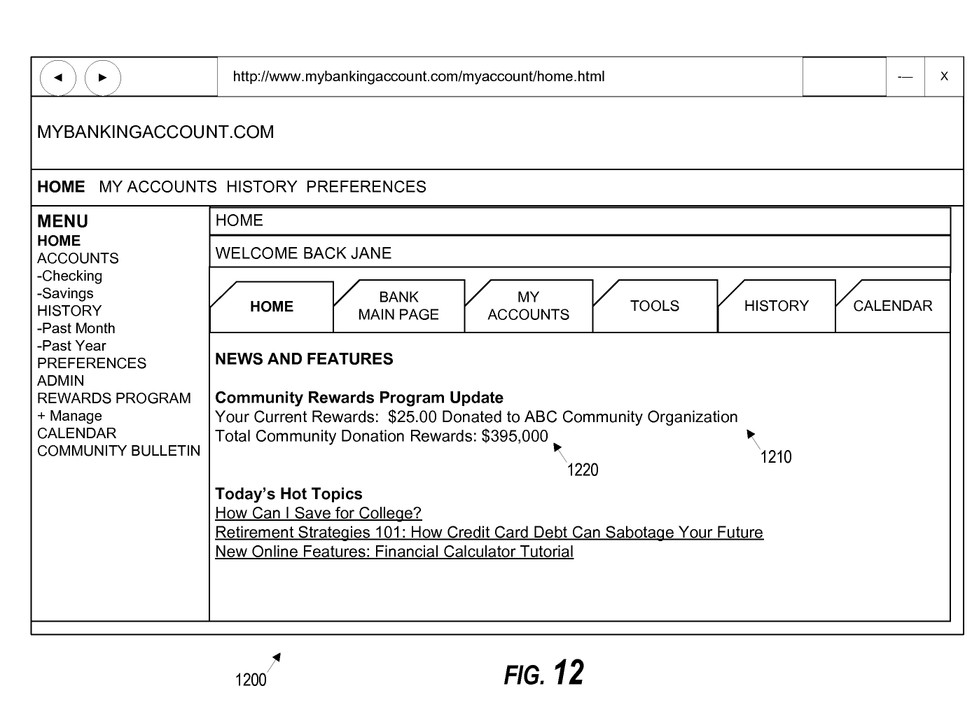

The GUI in FIG. 12 displays a community rewards update page 1200. The user's current donation rewards 1210 and also the total community donation rewards 1220 are presented in this example, but any type of reward can be displayed. This information may be obtained in accordance with the methods described herein with respect to the flow charts.

The online banking interface may includes other options or features in the interface, such as an option to view the history of transactions in the account (shown as the “History” link), schedule events (shown as the “Calendar” link), and set up administrative preferences (shown as the “Admin” link). It should be noted that various features may be included in the online banking system or any other online system, such as transmitting alerts and/or messages to the user via a handheld electronic device or computer. Furthermore, it should be understood that the online interface illustrated in FIGS. 8-12 are presented herein for exemplary purposes and may be in any other form to achieve various embodiments of the present invention.

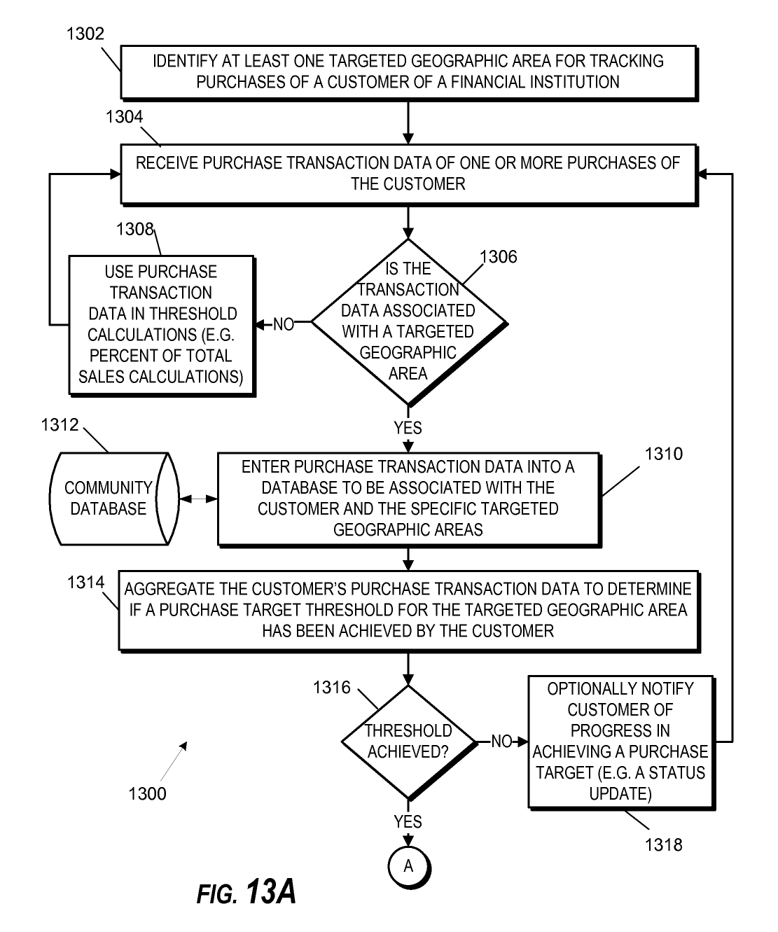

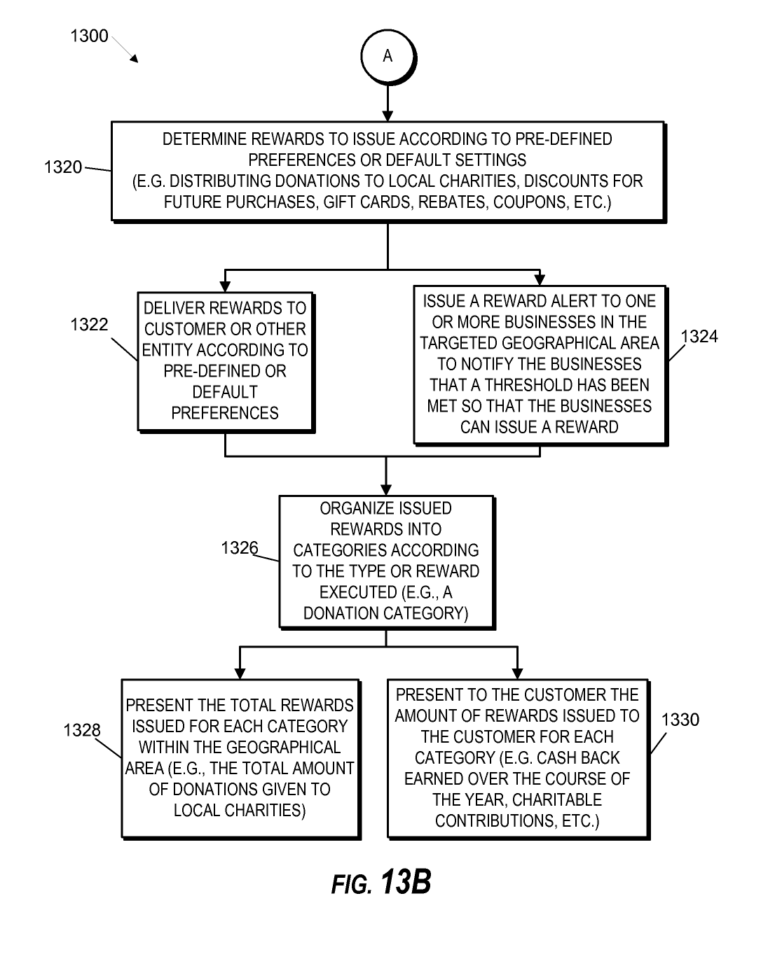

FIGS. 13A and 13B combine to provide a flow chart illustrating an example embodiment of a geography-based community rewards process 1300 in accordance with an exemplary embodiment of the invention. As represented by block 1302, at least one targeted geographic area for tracking purchases of a customer of a financial institution is identified. The customer of a financial institution may be an account holder, an agent of an account holder, an account administrator, a bank customer, or any other individual or organization using a financial product of the financial institution. The geographic area may be a country, state, province, county, city, town, district, area associated with a zip code or area code, group of cities, community, section of a region, or any other geographical area. For example, the geographical area may be three cities located within a western region of a state.

As represented by block 1304, the purchase transaction data of one or more purchases of the customer is received. As described above with regard to FIG. 1, the purchase transaction data may be information associated with a purchase transaction, such as debit or credit card transactions, check payments, automatic account payments, or any other financial transactions whether in document, electronic, or other form. In some embodiments, the financial institution receives the purchase transaction data from a business, a group of businesses, another financial institution, a service provider, a billing or payment service, or any organization that is associated with the customers' purchases. For example, if a person buys groceries at a grocery store with the customer's bank-issued debit card, a bank receives purchase transaction data when the store sends the data to the bank so that money can be debited from the customer's bank account. In other embodiments, a business or organization receives the purchase transaction data from the customer, another business, a financial institution, or any other individual or organization.

As represented by block 1306, a determination is made as to whether the purchase transaction data is associated with a targeted geographic area. As previously discussed, the purchase transaction data is any data associated with purchases made by a customer of a financial institution within or outside the boundaries of a geographical region. In some embodiments, the purchase transaction data is determined to be associated with a targeted geographic area if the transaction was executed at a location that is within the targeted geographic area (e.g., all purchases made in a particular city). In some embodiments, the purchase transaction data is determined to be associated with a targeted geographic area if the customer making the purchases is a resident of the targeted geographical area. Nonetheless, if the purchase transaction data is determined to be associated with a targeted geographic area, the method 1300 proceeds to step 1310, otherwise the method continues to block 1308.

As represented by block 1308, although the purchase transaction data is not determined to be associated with the targeted geographic area, the purchase transaction data may, in some embodiments of the invention, be still used in threshold calculations. The purchase transaction data that is not associated with a targeted geographic area can be used to calculate a percent of total purchases made by a customer of the bank. For example, a bank could calculate a percent threshold by dividing the customer's total purchase amount in a targeted geographical area using a bank card specific to a certain bank by the total purchase amounts made using the same bank card in any location (whether or not the purchases were made inside or outside of the targeted geographical area).

As represented by block 1310, purchase transaction data to be associated with the customer and the specific targeted geographic areas is entered into a database. The database may include any database operated by or located at the financial institution, a business, a franchise, a third party acting on behalf of a bank or business, or any other organization. In some embodiments, a financial institution enters into the database purchase transaction data stemming from purchases made by a customer of the financial institution in a geographical region. For example, a bank could track all purchase transactions made by any account-holder in a specific town by entering the purchase transaction data of these particular customers into a database. In other embodiments, a financial institution or other organization enters purchase transaction data of purchases made by a customer of the financial institution who is a resident of a targeted geographical region into a database. For example, the purchase transaction data to be associated with the specific targeted area could include credit card purchases that were not made within a targeted city, but were made by a resident of that city.

In some embodiments, a reward recipient must first agree with the financial institution's activities before participating in a community rewards program. For example, in some embodiments, a financial institution will not track purchases made using a financial institution account or enter purchase transaction data associated with that financial institution account in a database unless the financial institution account owner is fully aware of such financial institution activities and agrees to participate in the financial institution's activities. A financial institution customer may, for example, “opt in” or “opt out” of the community rewards program. In other embodiments, a financial institution or any other organization that tracks purchases and compiles purchase transaction data must comply with privacy guidelines, data usage guidelines, or any other law or regulation.

As represented by block 1312, a community database is illustrated. The community database 1312 includes purchase transaction data associated with the specific targeted geographic areas and more than one customer of a financial institution. For example, a bank could store all purchase transaction data of purchases made by residents of a city using a particular bank card in the community database. The community database is a database operated by a financial institution, a company, one or more businesses in a geographical location, a franchise, or any other organization. The data entered into the database of a particular customer or group of customers can be transferred to the community database. For example, a bank could keep a separate database for customers who reside in a targeted city or who make purchases in a targeted city and combine some or all of these separate databases into the community database. In other embodiments, the data entered into the community database is transferred to the database of a particular customer or group of customers. For example, a bank could transfer purchase transaction data in the community database to a database for purchases made by a household using a joint account to determine a percent threshold.

As represented by block 1314, the customer's purchase transaction data is aggregated to determine if a predefined purchase target threshold for the targeted geographic area has been achieved by the customer. As disclosed above with regard to FIG. 1, the purchase target threshold may be a purchased monetary amount, a number of purchases, a percent, a volume of purchases in a specific time period, or any other level, calculation, or formula based on the purchase transaction data associated with a geographic location. The purchase target threshold may be determined by a bank or other financial institution, a business at which the purchase takes place, businesses in a geographical location, a franchise, a service provider, or any other organization. For example, a bank could add up all of the purchases the customer has made for an entire month at a group of stores in a targeted county to determine if the customer's total purchase amount meets a targeted threshold of $250.00. In some embodiments, all purchase transaction data associated with a targeted geographical region is aggregated to determine if a predetermined threshold has been achieved by more than one customer. For example, a bank could tally the total number of bank card purchases made at a particular group of stores in a targeted city to determine if a predetermined threshold of three-hundred and fifty bank card transactions has been met by all customers who made purchases at those stores.

As represented by block 1316, a determination is made as to whether the purchase target threshold has been achieved. If the threshold is not achieved, the financial institution or other organization optionally can notify the customer of progress made in achieving the purchase target threshold as illustrated in block 1318. In some embodiments, if the predetermined threshold is achieved, a reward is issued.

As represented by block 1320, rewards to be issued are determined according to pre-defined preferences. Default preferences are preferences that are predefined by the entity issuing the reward, the entity determining if the purchase threshold has been met, the entity that manages the databases, the entity managing the community rewards program, or any other organization. For example, a store may issue a donation to a local charity equaling 5% of all purchases at the store using a bank card in compliance with a default preference determined by a bank.

As represented by block 1322, the rewards are delivered to the customer or other entity according to pre-defined or default preferences. The delivery may be by email, fax, automatic account credit, text, online message delivery, phone, or by any other method of delivery. For example, a bank may deliver a cash rebate to a customer by automatically crediting the customer's checking account with the amount of the rebate in accordance with default preferences.

As represented by block 1324, a reward alert is issued to notify one or more businesses in the targeted geographical region that the predetermined threshold has been met so that that the businesses can issue a reward. The businesses can be any entity, such as a store, a company, a franchise, a service provider, a chain, a group of businesses, an association, a wholesaler, or any other entity, organization or group of organizations that offer products/services for sale. For example, a restaurant franchise may email a promotional discount code to a bank card customer for use in local restaurant locations upon receiving an alert from a bank that the predetermined threshold has been met. In other embodiments, the rewards alert can be issued by the financial institution, a collective group of businesses in a geographical area, a franchise, a partnering company, or any other entity.

As represented by block 1326, the issued rewards are organized into categories according to the type of reward delivered. For example, checks or electronic account transfers delivered to a local charity would be organized into a “donation” category and a free pedicure or gift card for a pedicure would be organized as a “free product/service” category. In some embodiments the rewards are organized by a financial institution, a business, a group of businesses, or any other organization.

As represented by block 1328, the rewards issued for each category within the geographical area are presented to a customer. For example, a business may post the total donation given to charities within a particular region over the course of a year on its website. In some embodiments, the reward recipient is presented with the total rewards earned for each category in the geographical area on an online banking account or by email, text, phone, or by any other means for transmitting information.

As represented by block 1330, the total amount of rewards issued to the customer for each category is presented to the customer. Such presentation may be by email, phone, online messaging, text, online banking websites, electronic bank statements, or by any other means for presenting information. For example, a bank may present the total cash back earned over the course of a year or the amount of donations given to area public schools in a statement or on an online bank account.

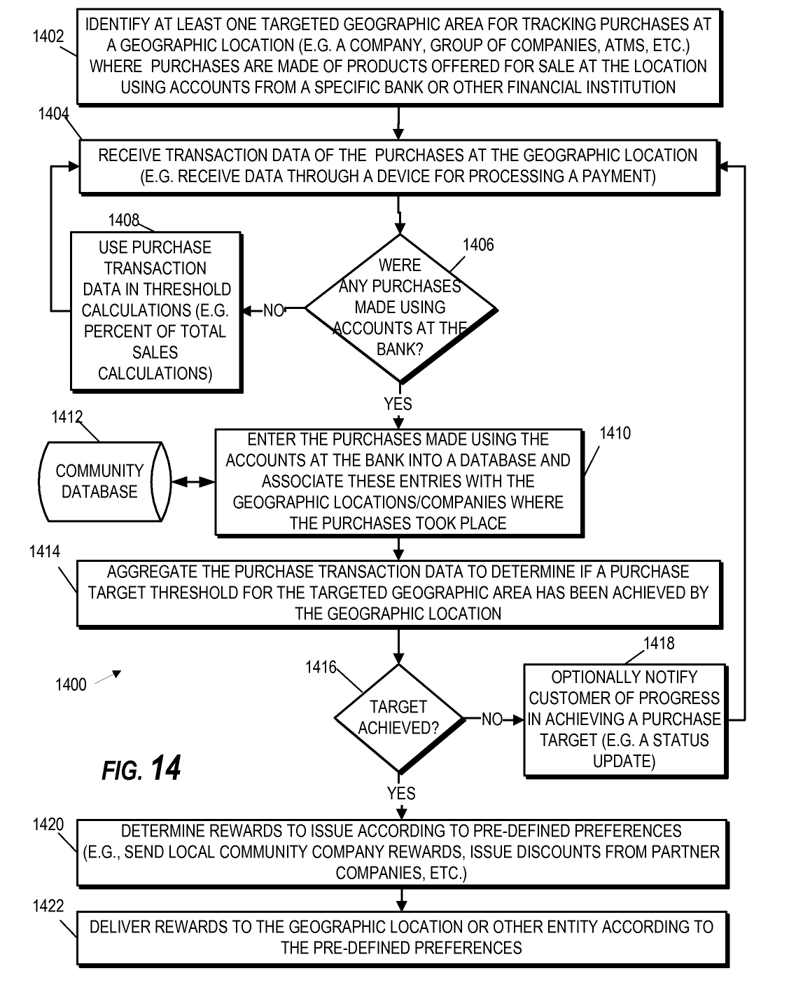

FIG. 14 provides a flow chart illustrating a community rewards process 1400 in accordance with an exemplary embodiment. As represented by block 1402, at least one targeted geographic area for tracking purchases at a geographic location where the purchases of products offered for sale at the geographic location are made using accounts from a specific bank or other financial institution are identified. The geographic location is a business, a company, a group of companies, an automatic teller machine (ATM), a franchise, a service provider, or any other location at which a purchase can be undertaken. For example, a service such as money withdrawal from a specific checking account can be purchased from an ATM located in a targeted geographical area in exchange for a fee.

As represented by block 1404, the purchase transaction data for the purchases at the geographic location is received. In some embodiments, the purchase transaction data is received by a device that processes a payment. For example, a debit/credit card reader or a check scanner may be used to process payments at checkout terminals. The purchase transaction data is received from the financial institution that provides the payment, any other financial institution, a third party, a business, or any other entity or organization that provides the purchase transaction data.

As represented by block 1406, a determination is made as to whether any of the purchases were made using accounts at a specific bank or other financial institution. As represented by block 1408, if the purchases were not made at the accounts at a common bank or other financial institution, the purchase transaction data can be used in threshold calculations as described above with regard to FIGS. 13A and 13B. For example, the purchase transaction data computations can relate to what percentage of the total transactions were made using a specific common bank (e.g., 35% of total transactions were made using the particular bank's accounts).

As represented by block 1410, purchases made using the account at the bank or other financial institution and that are associated with the geographic locations where the purchases took place are entered into a database. The database may include databases operated by or located at a financial institution, a business, a group of businesses, a franchise, a third party acting on behalf of a bank or business, or any other organization.

In block 1412, the community database is illustrated. In some embodiments, the community database includes the purchase transaction data of all geographic locations in the geographic area. For example, a bank could keep a separate database for each geographic location in the targeted geographic area and combine all of the data from each database into a common community database 1412.

As represented by block 1414, the purchase transaction data is aggregated to determine if a purchase threshold for the targeted geographic area has been achieved by the geographic location. The predefined threshold may be determined by the geographic location, a bank or other financial institution, a partner business, a group of business, a franchise, a service provider, or any other organization. In some embodiments, the financial institution determines the predefined threshold and the geographic location aggregates the purchase transaction data. In other embodiments, the geographic location determines the predefined threshold and the geographic location also aggregates the purchase transaction data.

As represented by block 1416, a determination as to whether the predetermined or purchase target threshold has been achieved is made. If the threshold is not achieved, the financial institution or other organization optionally notifies the customer of progress made in achieving a purchase target as illustrated in block 1418.

As represented by block 1420, a determination is made as to what rewards are to be issued according to pre-defined preferences. As represented by block 1422, rewards are delivered to the geographic location or other entity according to pre-defined preferences. In some embodiments, the rewards are initially delivered for further distribution. For example, a bank could deliver rebate checks to the chain of department stores where purchases are made using accounts from the bank so that the department store could distribute the cash rebate checks to customers who reach the predefined threshold. The other entity mentioned immediately above relates to a customer, a financial institution, a business, an organization in the geographic area, a local charity, or any other individual or organization receiving and/or distributing the reward. In am embodiment, an entity associated with the geographic location delivers the rewards. For example, an internet service provider could deliver a month of free service to customers who reach the predefined threshold.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described above with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wireline, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment, an entirely software embodiment (including firmware, resident software, micro-code, etc.), or an embodiment combining software and hardware aspects that may generally be referred to herein as a “module,” “application,” or “system.”

U.S. patent application Ser. No. ______ to Joa et al. and entitled “Merchant-Based Community Rewards” is filed concurrently with the present application and is hereby incorporated herein by reference in its entirety.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus comprising:
a memory system comprising stored therein a threshold associated with a reward, the memory system further comprising stored therein transaction data associated with a particular financial institution;
a processor communicably coupled to the memory system and configured to:
identify from the transaction data a group of transactions associated with a predefined community and time period;
aggregate a particular aspect of the group of transactions associated with the predefined community to determine a community total; and
determine that the reward should be provided to the community based on a comparison of the community total and the threshold.

2. The apparatus of claim 1, wherein the predefined community is defined, at least in part, by a predefined geographic area.

3. The apparatus of claim 2, wherein the group of transactions associated with the predefined geographic area comprises transactions made within the predefined geographic area.

4. The apparatus of claim 2, wherein the group of transactions associated with the predefined geographic area comprises transactions made by entities residing within the predefined geographic area.

5. The apparatus of claim 2, wherein the predefined geographic area comprises a municipality.

6. The apparatus of claim 2, wherein the predefined community is further defined, at least in part, by a particular merchant.

7. The apparatus of claim 1, wherein the particular aspect of the group of transactions comprises the values of transactions in the group of transactions.

8. The apparatus of claim 1, wherein the particular aspect of the group of transactions comprises the number of transactions in of the group of transactions.

9. The apparatus of claim 1, wherein the reward comprises a discount offered to the community.

10. The apparatus of claim 1, wherein the reward comprises a payment to an organization associated with the community.

11. The apparatus of claim 1, wherein the particular financial institution comprises a bank.

12. The apparatus of claim 1, wherein the group of transactions associated with the predefined community comprises purchases made from a merchant and using a financial account at the particular financial institution for payment for the purchase.

13. The apparatus of claim 1, wherein the predefined community is defined, at least in part, by social or familial relationships.

14. The apparatus of claim 1, further comprising:
a communication interface operatively coupled to the processor and configured to receive an indication by a consumer that the consumer desires to join the predefined community,
wherein the processor is configured to:
store in the memory system an association between the consumer and the predefined community based at least in part on the indication received from the consumer; and
identify the consumer's transaction data as being associated with the predefined community.

15. The apparatus of claim 1, further comprising:
a communication interface operatively coupled to the processor and configured to communicate with one or more consumers,
wherein the processor is further configured to use the communication interface to allow the one or more consumers to create the predefined community.

16. A computer-implemented method comprising:
accessing transaction data associated with a particular financial institution;
determining a threshold;
identifying from the transaction data a group of transactions associated with a predefined community and time period;
aggregating a particular aspect of the group of transactions associated with the predefined community to determine a community total; and
determining that a reward should be provided to the community based on a comparison of the community total and the threshold.

17. The computer-implemented method of claim 16, wherein the identifying from the transaction data the group of transactions associated with the predefined community comprises:
identifying transactions associated with a predefined geographic area.

18. The computer-implemented method of claim 17, wherein the identifying transactions associated with the predefined geographic area comprises:
identifying transactions made within the predefined geographic area.

19. The computer-implemented method of claim 17, wherein the identifying transactions associated with the predefined geographic area comprises:
identifying transactions made by entities residing within the predefined geographic area.

20. The computer-implemented method of claim 17, wherein the predefined geographic area comprises a municipality.

21. The computer-implemented method of claim 16, wherein the identifying from the transaction data the group of transactions associated with the predefined community comprises:
identifying transactions associated with a predefined geographic area and a particular merchant.

22. The computer-implemented method of claim 16, wherein the aggregating the particular aspect of the group of transactions associated with the predefined community to determine the community total comprises:
aggregating the values of transactions in the group of transactions associated with the predefined community.

23. The computer-implemented method of claim 16, wherein the aggregating the particular aspect of the group of transactions associated with the predefined community to determine the community total comprises:
aggregating the number of transactions in of the group of transactions associated with the predefined community.

24. The computer-implemented method of claim 16, wherein the reward comprises a discount offered to the community.

25. The computer-implemented method of claim 16, wherein the reward comprises a payment to an organization associated with the community.

26. The computer-implemented method of claim 16, wherein the particular financial institution comprises a bank.

27. The computer-implemented method of claim 16, wherein the identifying from the transaction data the group of transactions associated with the predefined community comprises:
identifying purchases made from a merchant and using a financial account at the particular financial institution for payment for the purchase.

28. The computer-implemented method of claim 16, wherein the predefined community is defined, at least in part, by social or familial relationships.

29. The computer-implemented method of claim 16, further comprising:
receiving an indication from a consumer that the consumer desires to join the predefined community;
storing in a memory system an association between the consumer and the predefined community based at least in part on the indication received from the consumer; and
identifying the consumer's transaction data as being associated with the predefined community.

30. The computer-implemented method of claim 16, further comprising:
receiving input from a consumer; and
creating the predefined community based on the input from the consumer.

31. The computer-implemented method of claim 30, further comprising:
communicating to other consumers invitations to join the predefined community.

32. A computer program product comprising a non-transitory computer readable medium having computer-executable program code stored therein, wherein the computer-executable program code comprises:
a first code portion configured to access transaction data associated with a particular financial institution;
a second code portion configured to identify from the transaction data a group of transactions associated with a predefined community and time period;
a third code portion configured to aggregate a particular aspect of the group of transactions associated with the predefined community to determine a community total; and
a fourth code portion configured to determine that a reward should be provided to the community based on a comparison of the community total and a pre-defined threshold.

33. The computer program product of claim 32, wherein the predefined community is at least partially based on a predefined geographic area.

34. The computer program product of claim 33, wherein the group of transactions associated with the predefined geographic area comprises transactions made within the predefined geographic area.

35. The computer program product of claim 33, wherein the group of transactions associated with the predefined geographic area comprises transactions made by entities residing within the predefined geographic area.

36. The computer program product of claim 33, wherein the predefined geographic area comprises a municipality.

37. The computer program product of claim 32, wherein the group of transactions associated with the predefined community comprises purchases made from a merchant and made using a financial account at the particular financial institution for payment for the purchase.

38. The computer program product of claim 32, wherein the predefined community is at least partially based on a predefined geographic area and a particular merchant.

39. An apparatus comprising:
a memory system comprising transaction data stored therein;
a processor communicably coupled to the memory system and configured to:
identify from the transaction data a group of transactions associated with a predefined geographic area;
aggregate a particular aspect of the group of transactions associated with the predefined geographic area to determine a total; and
determine that a reward should be provided to one or more entities based on the total.

40. The apparatus of claim 39, wherein the processor is configured to identify from the transaction data the group of transactions associated with the predefined geographic area by:
identifying from the transaction data a group of transactions made by a particular entity residing within the predefined geographic area.

41. The apparatus of claim 40, wherein the particular entity comprises a particular consumer.

42. The apparatus of claim 39, wherein the processor is configured to identify from the transaction data the group of transactions associated with the predefined geographic area by:
identifying from the transaction data a group of transactions made by a particular entity and made within the predefined geographic area.

43. The apparatus of claim 42, wherein the particular entity comprises a particular merchant.

44. The apparatus of claim 39, wherein the transaction data is associated with a particular financial institution.

45. The apparatus of claim 39, wherein the group of transactions associated with the predefined geographic area comprises transactions made by multiple different consumers.

46. The apparatus of claim 39, wherein the group of transactions associated with the predefined geographic area comprise transactions made by multiple different consumers using transaction devices associated with a particular financial institution.

47. The apparatus of claim 39, wherein the transaction data includes information about transactions made across an overall geographic area, and wherein the predefined geographic area is smaller than the overall geographic area represented by the transaction data.

48. The apparatus of claim 39, wherein the predefined geographic area comprises a municipality.

49. The apparatus of claim 39, wherein the group of transactions associated with the predefined geographic area comprises transactions made within the predefined geographic area.

50. The apparatus of claim 39, wherein the particular aspect of the group of transactions comprises the values of transactions in the group of transactions.

51. The apparatus of claim 39, wherein the particular aspect of the group of transactions comprises the number of transactions in of the group of transactions.

52. The apparatus of claim 39, wherein the one or more entities comprises an organization within the predefined geographic area.

53. The apparatus of claim 39, wherein the one or more entities comprises one or more consumers within the predefined geographic area.

54. The apparatus of claim 39, wherein the processor is configured to identify from the transaction data the group of transactions associated with the predefined geographic area by:
identifying from the transaction data a group of purchases associated with the predefined geographic area and for a particular one or more products.

55. The apparatus of claim 39, wherein the processor is further configured to trigger issuance of the reward by notifying one or more businesses of a determination that the reward should be provided.

56. The apparatus of claim 39, wherein the memory system further comprises a threshold stored therein associated with the reward, and wherein the processor is configured to determine that the reward should be provided to one or more entities based on a comparison of the total with the threshold.

57. The apparatus of claim 56, wherein the processor is configured to issue a notification of progress made toward reaching the threshold.

58. A computer-implemented method comprising:
identifying, using a processor, a group of transactions associated with a predefined geographic area;
aggregating, using a processor, a particular aspect of the group of transactions associated with the predefined geographic area to determine a total; and
determining that a reward should be provided to one or more entities based on the total.

59. The method of claim 58, wherein identifying the group of transactions associated with the predefined geographic area comprises:
identifying a group of transactions associated with the predefined geographic area and made by multiple different consumers using transaction devices associated with a particular financial institution.

60. The method of claim 58, wherein the predefined geographic area comprises a particular municipality.

61. The method of claim 58, wherein determining that the reward should be provided to one or more entities comprises comparing the total with a reward threshold.
